(19) United States
(12) Patent Application Publication
(10) Pub. No.: US 2026/0196056 A1
(43) Pub. Date: Jul. 9, 2026

(54) BIRD'S EYE VIEW (BEV) REPRESENTATION GENERATION UTILIZING DATA FROM VEHICLE-TO-EVERYTHING (V2X) MESSAGES

(71) Applicant: QUALCOMM Incorporated, San Diego, CA (US)

(72) Inventors: Jean-Philippe MONTEUUIS, Northborough, MA (US); Mohit NARULA, San Diego, CA (US); Jonathan PETIT, Wenham, MA (US); Cong CHEN, San Diego, CA (US)

(21) Appl. No.: 19/015,148

(22) Filed: Jan. 9, 2025

(51) Int. Cl. G06V 20/58; G06T 17/00; G06V 10/82

(52) U.S. Cl. CPC G06V 20/58; G06T 17/00; G06V 10/82; G06T 2210/56

(57) ABSTRACT

The present disclosure provide techniques for object detection. A method may include extracting a plurality of vehicle-to-everything (V2X) features from a first plurality of V2X messages, wherein the first plurality of V2X messages comprise information about one or more first objects in a scene during a first time period; generating a bird's eye view (BEV) representation of the scene based on, at least, projecting the plurality of V2X features from a V2X space to a BEV space; and detecting, based on the BEV representation, at least a first object among the one or more first objects in the scene.

### INTRODUCTION

### Field of the Disclosure

Aspects of the present disclosure relate to techniques for object detection.

### Description of Related Art

The field of computer vision has observed significant advancements in recent years with the development of sophisticated perception systems that enable (e.g., autonomous) intelligent systems, such as vehicles (e.g., autonomous vehicles) and/or robots, to perceive their surroundings. For example, a perception system of a vehicle may be used to sense and build a reliable and detailed representation of an environment surrounding the vehicle (e.g., referred to herein as a “perception output”), such as to enable the vehicle to understand and/or safely navigate its environment. Sensor data from various types of sensors installed at, or on, the vehicle, such as still or moving image sensor(s) (e.g., camera(s)), light detection and ranging (LiDAR) equipment, a sound navigation and ranging (SONAR) sensor(s), a radio detection and ranging (RADAR) sensor(s), and/or the like, may be combined (e.g., using sensor data fusion techniques) to generate the perception output.

One example perception output that may be generated includes a bird's eye view (BEV) representation, which is a two-dimensional (2D), top-down view of a three-dimensional (3D) or 2D scene. A BEV representation may be generated based on projecting sensor data from one or more sensors onto a common reference grid structure, commonly referred to as a “BEV grid” (e.g., a 2D or a 3D grid where each cell of the grid represents a spatial area). In certain aspects, the BEV representation may integrate sensor data from multiple sensors such as to provide a more comprehensive and/or accurate view of a scene (e.g., depth data from LiDAR sensors combined with rich visual information from image sensors). For example, features may be extracted from multi-modal sensor data using modality-specific encoders (e.g., an image encoder, such as a residual network (ResNet), may be used to extract features from images, while a LiDAR encoder, such as PointNet++, may be used to extract features from point cloud data), converted into BEV features, and unified in a shared BEV space (e.g., a BEV grid) to generate a BEV representation.

As used herein, “BEV features” may refer to particular attributes or states of objects in a scene (e.g., a 2D scene or a 3D scene) that are transformed and mapped into the BEV grid. An example BEV feature may include a location of an object in the scene, expressed as a set of x and y coordinates corresponding to one or more cells in a BEV grid. Other example BEV features may include values entered into the cells of a BEV grid, such as (1) a value entered for a respective cell indicating the existence of an object in the cell (e.g., a value of one indicating the existence of an object, otherwise a value of zero), (2) a value indicating the probability of an object existing in a respective cell (e.g., a value between 0% and 100%), (3) a value indicating the class of an object associated with a respective cell (e.g., a value of zero indicating no object, a value of one indicating a first class, such as a car, a value of two indicating a second class, such as a pedestrian, etc.).

A BEV representation may help to simplify complex sensor data such as to provide a unified spatial understanding of objects, and their relationships, in a defined space. Thus, BEV representations may be useful for object detection, particularly in applications, such as (e.g., autonomous) driving and/or robotics. “Object detection” is a computer vision task used to localize and classify objects of interest, which may be in the area surrounding a particular object (e.g., an ego vehicle, a robot, etc.). Localization may involve determining the location of an object of interest in a BEV grid, while classification may involve assigning a class (e.g., “pedestrian,” “vehicle,” etc.) to that object. In many aspects, object detection is the foundation for other computer vision tasks generally performed during autonomous operation, such as object tracking, event detection, motion control, and/or path planning, among others.

### SUMMARY

Certain aspects provide a method for object detection by an apparatus. The method includes extracting a plurality of vehicle-to-everything (V2X) features from a first plurality of V2X messages, wherein the first plurality of V2X messages comprise information about one or more first objects in a scene during a first time period; generating a bird's eye view (BEV) representation of the scene based on, at least, projecting the plurality of V2X features from a V2X space to a BEV space; and detecting, based on the BEV representation, at least a first object among the one or more first objects in the scene.

Certain aspects provide a method for object detection by an apparatus. The method includes sending an indication of a capability of the apparatus to generate, from at least V2X messages, a BEV representation of a scene; and obtaining, based on the indication of the capability, one or more first V2X messages from one or more other apparatuses.

Certain aspects provide a method for object detection by a first apparatus. The method includes obtaining, from a second apparatus, a first V2X message comprising information about the second apparatus in a scene during a first time period; and generating, based on at least the first V2X message, a BEV representation of the scene comprising the second apparatus during a second time period.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts example limitations associated with creating a bird's eye view (BEV) representation from sensor data associated with a single apparatus.

FIG. 2 depicts an example system for object detection using a BEV representation generated based on vehicle-to-everything (V2X) message data.

FIG. 3 depicts an example workflow for V2X message processing.

FIG. 4 depicts an example artificial intelligence (AI) architecture.

FIG. 5 depicts an example artificial neural network (ANN).

FIG. 6 depicts an example method for object detection.

FIG. 7 depicts another example method for object detection.

FIG. 8 depicts another example method for object detection.

FIG. 9 depicts an example sensor and computing system.

FIG. 10 depicts aspects of an example apparatus.

### DETAILED DESCRIPTION

Aspects of the present disclosure provide apparatuses, methods, processing systems, and computer-readable mediums for utilizing data from vehicle-to-everything (V2X) messages, such as exchanged between vehicles, to generate (e.g., more accurate and comprehensive) BEV representations of a scene. For example, aspects described herein provide a V2X-BEV pipeline, which may be utilized to process and project data from V2X messages into a BEV space, such as to generate a BEV representation. In certain aspects, the BEV representations may be used by the vehicles to perform object detection, among other computer vision tasks.

In certain aspects, a BEV representation may be generated to represent a physical environment (e.g., a 2D or 3D scene), including any object(s) (e.g., such as vehicles, pedestrians, traffic lights, road markings, obstacles, etc.), surrounding a (e.g., autonomous) vehicle during a time period (e.g., such as at time T). The vehicle may be referred to as the “ego” vehicle given the BEV representation is generated with respect to that vehicle. To create the BEV representation, data from the one or more sensors located at, or on, the ego vehicle may be obtained and used to provide one or more views of the ego vehicle's surroundings, referred to as a “perspective view.” The data from the sensor(s) may be processed by one or more modality-specific encoders, which may use machine learning (ML) and/or other processing techniques to identify features from each view and provide data representing such features in a more compact form, such as a vector and/or tensor representation. The extracted features may be projected onto a BEV grid, essentially “splatting” the features onto the grid to create a unified representation (e.g., a BEV representation) of the scene surrounding the ego vehicle. For example, in certain aspects, the extracted features may be transformed into the BEV representation using a view transform, which may combine the extracted data from the perspective views into the combined top-down perspective. In certain aspects, sensor fusion may be employed during this process to combine complementary data from multiple sensors. For example, sensor fusion techniques may be used to integrate features from different sensor modalities, such as depth, motion, and texture, into a single cohesive data structure, such as a BEV tensor. In certain aspects, a “BEV tensor” may refer to an n-dimensional array that represents spatial features of a scene from a top-down perspective. In certain aspects, a “BEV tensor” may organize the features of the scene into a grid, where each cell (or voxel) of the grid corresponds to a specific area around the ego vehicle and includes information derived from the sensor data, such as objects in the area, their distance, motion, and/or other attributes. By transforming the ego vehicle's sensor data into a grid-based, top-down perspective, BEV may help to improve object detection, enabling the ego vehicle to detect, classify, and track objects with increased accuracy, to enhance overall object detection and tracking performance by the ego vehicle. Accordingly, the ego vehicle (e.g., an autonomous vehicle) may be able to better perceive their environment, make informed decisions, and navigate safely, such as without human intervention.

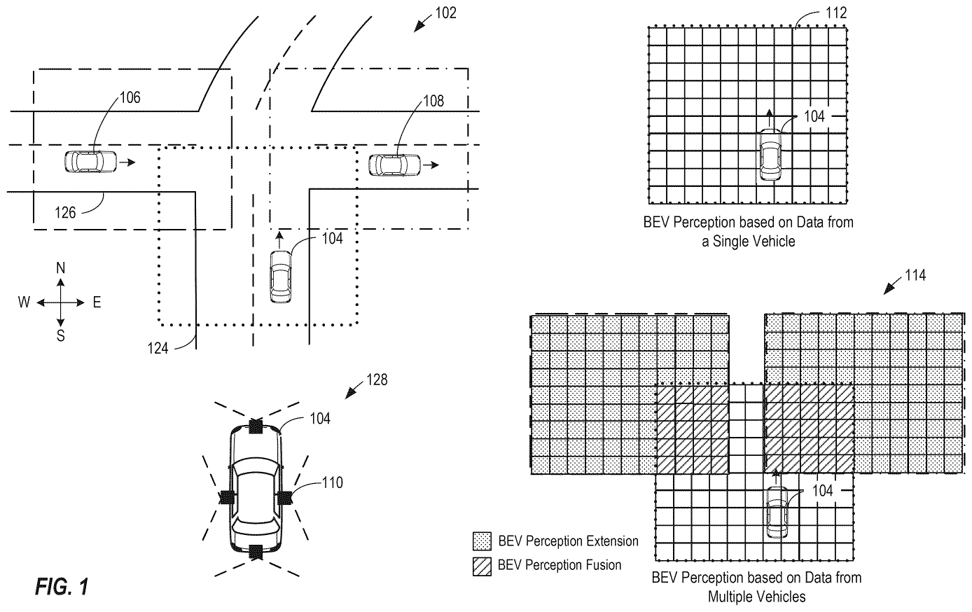

A BEV representation constructed by the perception system of a single vehicle, such as based on sensor data only from sensor(s) installed at, or on, the vehicle, however, may, in some cases, suffer from technical problems of low accuracy and/or insufficient data. For example, data from a single vehicle for scene perception may not allow for a complete understanding of the environment surrounding the vehicle due to limitations of the sensor(s) associated with the vehicle (e.g., such as limited sensor range) and/or due to one or more occluded objects in a line of sight (LoS) of the vehicle's sensor(s). For example, a direct path between a sensor located at, or on, the vehicle and an object in the environment surrounding the vehicle may include one or more physical obstructions (e.g., such as buildings, trees, other vehicles, traffic signs, etc.); thus, the sensor may not be able to accurately detect the object when scanning the environment. Such limitations associated with creating a BEV representation from sensor data associated with a single vehicle is depicted in FIG. 1.

As shown in FIG. 1, an example environment 102 (depicted from a BEV) may include multiple objects, such as a vehicle 104, a vehicle 106, and a vehicle 108. Vehicle 104 may be traveling north along a road 124, and vehicles 106 and 108 may be traveling east along a road 126. Road 124 and road 126 may perpendicularly intersect.

In this example, each of vehicles 104, 106, and 108 may represent vehicles (e.g., autonomous or semi-autonomous vehicles) in environment 102. For example, vehicle 104 may include a perception system used to sense and interpret environment 102 surrounding vehicle 104 through one or more sensors 110 installed at, or on, vehicle 104, such as to enable vehicle 104 to understand and/or safely navigate environment 102, such as without human intervention. An example sensor 110 installed at, or on, vehicle 104 may include an image sensor (e.g., a camera), LiDAR equipment, a SONAR sensor, a RADAR sensor, and/or the like. In certain aspects, vehicle 104 may include only a single sensor 110, whereas in certain other aspects, vehicle 104 may include multiple sensors 110. The multiple sensors may be used to capture environment 102 surrounding vehicle 104, from different angles and/or perspectives, as multiple frames (e.g., images, point clouds, etc.).

For example, as shown at 128 in FIG. 1, multiple sensors 110 may be mounted at, or on, vehicle 104, such that each sensor 110 is facing a different direction associated with vehicle 104. A front-viewing sensor 110 may capture the scene in front of vehicle 104 at a first set of frames, a rear-viewing sensor 110 may capture the scene behind vehicle 104 as a second set of frames, a right-viewing sensor 110 may capture the scene to the right of vehicle 104 as a third set of frames, and a left-viewing sensor 110 may capture the scene to the left of vehicle 104 as a fourth set of frames.

In certain aspects, sensor data from the four sensors 110 associated with vehicle 104 may be used to construct a BEV representation 112 of the scene, from the perspective of vehicle 104, during a time period (e.g., at time 7). Due to the limited perception range of sensors 110 associated with vehicle 104, the BEV representation 112 may lack important information, which may be necessary for safely navigating environment 102. For example, as shown in FIG. 1, due to the limited perception range of at least the front-viewing sensor 110 and the right-viewing sensor 110, BEV representation 112 may fail to include any information about vehicle 106, such as the position of vehicle 106 in environment 102 during the particular time period. Thus, if vehicle 104 determines to proceed with crossing the intersection, one or more bad outcomes may be inevitable, such as the collision of vehicle 104 with vehicle 106. Although, in this example, the BEV representation 112 is inadequate due to the limited perception range of sensors 110 associated with vehicle 104, in some other examples, BEV representation 112 may be inadequate due to obstruction(s) blocking one or more views of vehicle 106, vehicle 108, and/or other objects of interest (e.g., traffic signs, pedestrians, etc.) to vehicle 104 in environment 102 from sensor(s) 110.

Vehicle 106 and vehicle 108 may include similar respective perception systems and sensor(s), such as to create a BEV representation from the perspective of each of vehicles 106 and 108.

As represented by this scenario, it may be important to collect and fuse together sensor data from multiple vehicles to generate a more comprehensive and accurate BEV representation of environment 102. For example, as shown at 114 in FIG. 1, sensor data from vehicle 106 and vehicle 108 may be used to generate a BEV representation that provides a more accurate understanding of environment 102. Specifically, the area perceived by vehicle 104 may be significantly extended, and the perception accuracy of areas of environment 102 perceived by multiple vehicles (e.g., such as both vehicle 104 and vehicle 106 or both vehicle 104 and vehicle 108) may be improved (e.g., the confidence that an object is present or not within these areas may be increased). In certain aspects, the BEV representation created based on sensor data from multiple vehicles may advantageously provide vehicle 104 with information about object(s) in environment 102 that are out of sensor LoS for one or more sensors 110 associated with vehicle 104 and/or are occluded by other object(s) in the scene.

While the aforementioned benefits, such as improved environmental perception, may be realized when constructing BEV representations using sensor data from multiple vehicles, construction of such BEV representations may be limited, such as based on the sensor data that can be used for BEV representation construction. In particular, certain frameworks for constructing BEV representations using shared sensor data may be limited to a specific type of sensor data (e.g., only data from image sensors, only data from LiDAR, etc.) and/or sensor format/output. As an illustrative example, in FIG. 1, vehicle 104 may use a framework for generating a BEV representation from the perspective of vehicle 104. The framework may be designed to use LiDAR point cloud data, having a first format (e.g., LiDAR point cloud data may be represented in multiple ways), from vehicle 104, vehicle 106, and/or vehicle 108 (among other vehicles in environment 102, which are not shown in FIG. 1). Sensors 110 associated with vehicle 104 may include LiDAR sensors configured to generate LiDAR point cloud data, having the first format, when scanning environment 102. However, sensors associated with vehicle 106 may include LiDAR sensors configured to generate LiDAR point cloud data, having a second format, when scanning environment 102, while vehicle 108 may include image sensors configured to generate image data when scanning environment 102.

Different formats of LiDAR point cloud data, such as generated by sensors 110 associated with vehicle 104 and sensors associated with vehicle 106, may include raw points, meshes, and voxels, to name a few. Raw point cloud sets of discrete 3D points may be obtained from 3D scanners and/or depth cameras. Each point may be represented by its x, y, and z coordinates and, in some cases, may include additional attributes, such as color and/or intensity. Meshes are collections of vertices, edges, and faces that define the surface of a 3D object. Meshes may provide a more structured representation compared to point clouds, as the connection between points is explicitly defined. Voxels are the 3D equivalent of pixels in 2D images. Voxels may represent 3D space as a regular grid of cubic elements, where each voxel includes a value indicating the presence or absence of an object.

Vehicle 106 and/or vehicle 108 may communicate the sensor data to vehicle 104; however, vehicle 104 may not be able to use the communicated sensor data to generate the BEV representation (e.g., at least because the data does not include LiDAR point cloud data or because the data includes LiDAR point cloud data but the data is associated with the second format instead of the first format). Thus, generation of the BEV representation based on sensor data from vehicle 106 and/or vehicle 108 may not be possible. As illustrated by the provided example, technical problems associated with BEV representation generation may include the lack of interoperability among vehicles due to, at least, the absence of standardization associated with shared sensor data.

Further, sharing sensor data among vehicles may be resource-intensive. For example, vehicles may generate high-volume, high-frequency sensor data (e.g., sensor data payloads may comprise raw data, which is unprocessed, in its original form and thereby tends to be larger in volume). Sharing this data among vehicles may require substantial bandwidth. Further, as the number of vehicles in the network increases, the amount of data being communicated between these vehicles may grow proportionally, resulting in further reduction of the available bandwidth and/or increased network congestion. Networks having limited bandwidth may be easily overwhelmed by large data volumes needing to be communicated between vehicles, especially in dense environments with many vehicles, such as to generate BEV representations based on sensor data from multiple vehicles.

Certain aspects described herein overcome the aforementioned technical problems associated with the generation of BEV representations from multi-vehicle sensor data, such as the lack of interoperability between vehicles and increased overhead, and provide a technical benefit to the field of computer vision. Specifically, certain aspects described herein provide a V2X-BEV pipeline that may utilize data from V2X communications to generate BEV representations. The V2X-BEV pipeline may include performing techniques such as V2X message processing, V2X feature extraction, and V2X feature projection from a V2X space to a BEV space, such as to generate BEV representations from the perspective of different vehicles. In certain aspects, a generated BEV representation may include information about one or more objects in a scene during a time period, and thus may be used for, at least, object detection by the vehicles.

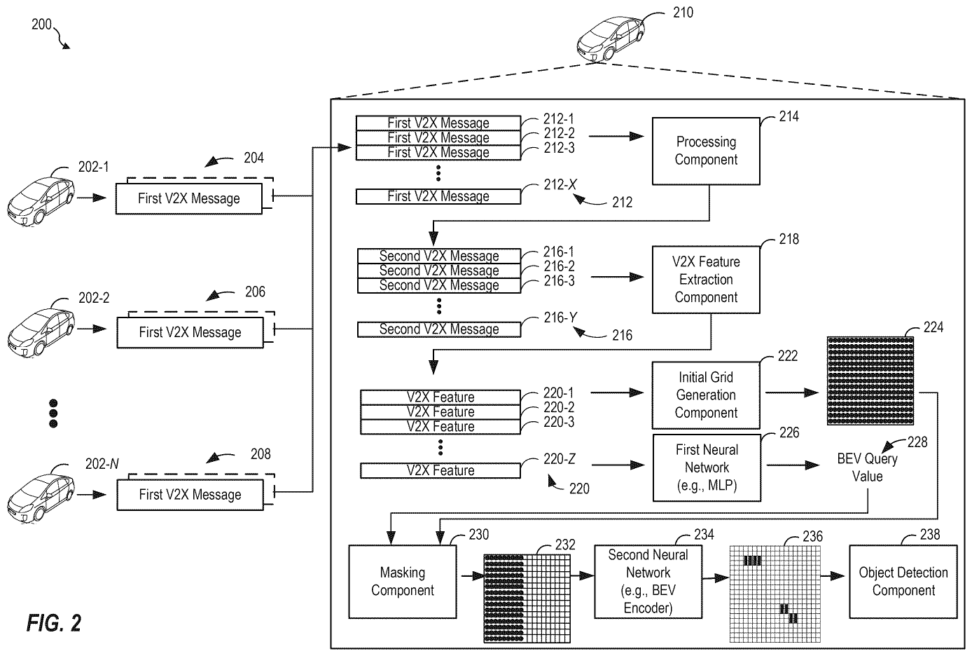

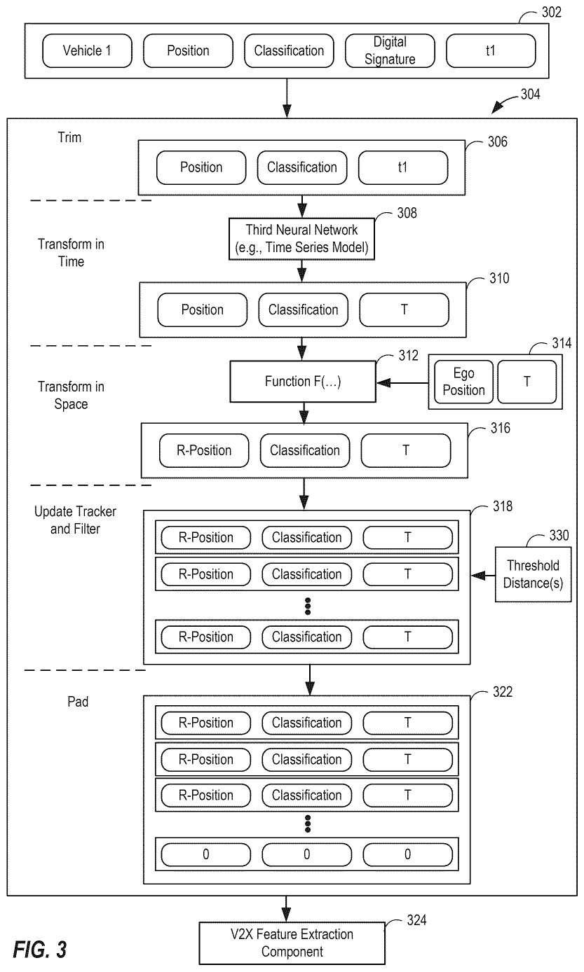

For example, V2X messages sent between a first vehicle and a second vehicle positioned in a scene may include information about one or more objects (e.g., the vehicles themselves and/or other object(s), such as pedestrian(s), traffic sign(s), etc.) in the scene. The information about a respective object may include state data associated with the respective object, such as its position, velocity, acceleration, heading, classification, and/or the like, during a time period. The first vehicle may process V2X messages received from the second vehicle, extract V2X features from the processed V2X messages, and generate a BEV representation based on, at least, projecting the extracted V2X features, associated with the V2X messages from the second vehicle, from a V2X space to a BEV space. Similarly, the second vehicle may process V2X messages received from the first vehicle, extract V2X features from the processed V2X messages, and generate a BEV representation based on, at least, projecting the extracted V2X features, associated with the V2X messages from the first vehicle, from a V2X space to a BEV space. Additional details related to V2X message processing, V2X feature extraction, and V2X feature projection are described in detail below with respect to FIGS. 2 and 3.

In certain aspects, a first vehicle may obtain V2X messages from a second vehicle, such as for generating BEV representation(s), based on the first vehicle providing the second vehicle with an indication that the first vehicle is capable of generating BEV representations from V2X messages. For example, the first vehicle may send an indication of a capability of the first vehicle to generate a BEV representation of a scene from V2X messages. In response to receiving this capability indication, the second vehicle may send, to the first vehicle, one or more V2X messages. The first vehicle may use, at least, the V2X message(s) from the second vehicle to generate a BEV representation, such as based on performing V2X message processing, V2X feature extraction, and V2X feature projection.

As described herein, some wireless communications systems support vehicle-to-everything (V2X) communications, in which vehicles (e.g., example user equipments (UEs)) in a system can communicate with other wireless devices, including other vehicles and/or roadside infrastructure such as roadside units. For example, V2X technology implemented at a vehicle may enable multiple communication modes, such as vehicle-to-vehicle (V2V), vehicle-to-infrastructure (V2I), vehicle-to-pedestrian (V2P), vehicle-to-network (V2N), and/or vehicle-to-device (V2D). V2X communication may involve the exchange of V2X messages, where a V2X message is a data packet transmitted wirelessly between a vehicle and any other entity in its environment. Example V2X messages may include basic safety messages (BSMs) and/or cooperative awareness messages (CAMs), among other types.

In some cases, V2X messages are standardized, meaning they follow a set of defined protocols and formats, allowing vehicles, such as from different manufacturers, to understand and interpret each other's communication effectively. Thus, aspects described herein utilizing data from V2X messages to generate BEV representations may help to overcome the technical problems associated with the lack of interoperability between vehicles for use of exchanged sensor data for a similar purpose. For example, because the use of V2X messages are standardized across vehicles, BEV representation generation may utilize any V2X message from any vehicle when generating a BEV representation, such as to generate a more accurate and/or comprehensive understanding of a scene. This improved scene understanding may help to enhance an autonomous vehicle's decision-making capability, improve the autonomous vehicle's ability to avoid obstacles, and/or enable the autonomous vehicle to operate more effectively in a wide range of environments and/or driving conditions.

In certain aspects, the use of V2X messages for generating BEV representations, as described herein, may further overcome non-line-of-sight (NLOS) issues encountered when using only sensor data obtained from sensors located at, or on, a vehicle. For example, a vehicle may be able to detect objects (e.g., surrounding the vehicle) that the vehicle may not have previously detected using only sensor(s) associated with the vehicle, at least due to (1) the objects being blocked by obstacles, such as other vehicles, trees, etc. and/or (2) the objects being out of sensor range of the sensor(s) associated with the vehicle. Certain aspects are described herein with respect to an autonomous vehicle exchanging V2X message data and/or using V2X messages for generating BEV representations, however it should be understood that other suitable vehicles or devices (e.g., road service units) may similarly exchange V2X message data and/or use V2X messages for generating BEV representations.

### Example System for Object Detection

FIG. 2 depicts an example system 200 for object detection using a BEV representation generated based on V2X message data. As shown, system 200 includes a vehicle 210, also referred to herein as “ego vehicle 210,” in communication with vehicles 202-1, 202-2, through 202-N, where N is an integer greater than zero (e.g., collectively referred to herein as “vehicles 202” and individually referred to herein as “vehicle 202”). Ego vehicle 210 and each vehicle 202 may be equipped with V2X technology for exchanging first V2X messages 212-1 through 212-X (e.g., where X is an integer greater than zero) (e.g., collectively referred to herein as “first V2X messages 212” and individually referred to herein as “first V2X message 212”) with each other, other entities, devices, and/or infrastructure. In certain aspects, ego vehicle 210 obtains and utilizes first V2X messages from vehicles 202 to generate a BEV representation 236. For example, a V2X-BEV pipeline may be used to process first V2X messages 212, extract V2X features, and project these features into a BEV space. Such steps performed for the V2X-BEV pipeline to transform the first V2X messages 212 into the BEV representation 236 are shown in FIG. 2, and may occur at ego vehicle 210.

For example, in certain aspects, first V2X messages 212 may include first V2X message(s) 204 from vehicle 202-1. In certain aspects, first V2X message(s) 204 may include information about one or more objects (e.g., vehicle 202-1 itself, other vehicles 202, pedestrians, traffic signs, etc.) in a scene during a first time period (e.g., time t−1). The information about a respective object may include state data for the respective object during the first time period, cryptographic data (e.g., such as a digital signature) and/or identification data (e.g., such as a numerical identifier or a StationId associated with the respective vehicle). In certain aspects, the state data may include mobility data (e.g. position, heading, speed, etc.) associated with the respective object during the first time period. In certain aspects, the state data may include classification data (e.g., object type, width, length, etc.) associated with the respective object during the first time period.

In certain aspects, first V2X messages 212 may include first V2X message(s) 206 from vehicle 202-2. In certain aspects, first V2X message(s) 206 may include information about one or more objects (e.g., vehicle 202-2 itself, other vehicles 202, pedestrians, traffic signs, etc.) in the scene during the first time period (e.g., time t−1). In certain aspects, first V2X message(s) 206 may include information about one or more of the same objects associated with first V2X message(s) 204.

In certain aspects, first V2X messages 212 may include first V2X message(s) 208 from vehicle 202-N. In certain aspects, first V2X message(s) 208 may include information about one or more objects (e.g., vehicle 202-N itself, other vehicles 202, pedestrians, traffic signs, etc.) in the scene during the first time period (e.g., time t−1). In certain aspects, first V2X message(s) 208 may include information about one or more of the same objects associated with first V2X message(s) 204 and/or first V2X message(s) 206.

In certain aspects, V2X messages 212 obtained from vehicles 202 include standardized BSM messages. In certain aspects, V2X messages 212 obtained from vehicles 202 include standardized CAM messages. Although aspects herein are described with respect to BSM and/or CAM messages, in some other aspects, the techniques herein may be used to generate BEV representations from other types of V2X messages.

In certain aspects, ego vehicle 210 may obtain V2X messages 212 from vehicle(s) 202 based on ego vehicle 210 providing one or more of the vehicles 202 with an indication that ego vehicle 202 is capable of generating BEV representations from V2X messages. For example, in response to receiving this capability indication, one or more of the vehicles 202 may send, to ego vehicle 210, one or more V2X messages 212.

After obtaining first V2X messages 212, a processing component 214 of ego vehicle 210 may process first V2X messages 212 to generate second V2X messages 216. Processing the first V2X messages 212, by processing component 214, may include trimming the first V2X messages 212, transforming the first V2X messages 212 in time, transforming the first V2X messages 212 in space, updating a tracker with first V2X messages 212, filtering at least the first V2X messages 212 included in the tracker, and/or padding the tracker that includes the first V2X messages 212. Further details related to processing first V2X messages 212 are depicted and described below with respect to FIG. 3.

A V2X feature extraction component 218, of ego vehicle 210, may then extract V2X features 220 (e.g., V2X features 220-1 through 220-Z, where Z is an integer greater than zero) from second V2X messages 216. For example, V2X feature(s) 220-1 may be extracted for second V2X message 216-1, V2X feature(s) 220-2 may be extracted for second V2X message 216-2, V2X feature(s) 220-3 may be extracted for third V2X message 216-3, etc. A number and/or type of V2X feature(s) extracted for two second V2X messages 216 may be the same or different.

A V2X feature 220 may include (1) first data included in a first V2X message 212 and/or (2) second data computed based on the first data included in the first V2X message 212.

In one example, second data may include the respective position of each of the four corners of a vehicle 202 that generated a first V2X message 212 sent to ego vehicle 210, which was then used to generate a second V2X message 216. For example, second V2X message 216 may include information about the width, the length, and the coordinates (e.g., position and/or heading of the center of the vehicle 202 relative to the coordinates (e.g., position and/or heading) of the ego vehicle 210. V2X feature extraction component 218 may compute the respective position of each of the four corners of vehicle 202 relative to the coordinates of ego vehicle 210 based on the information included in second V2X message 216.

In certain aspects, a convolutional neural network (CNN), such as ResNet, may be used by V2X feature extraction component 218 to extract V2X features 220. In certain aspects, a transformer, such as TabTransformer (e.g., a deep learning ML model that applies a transformer architecture to tabular data), may be used by V2X feature extraction component 218 to extract V2X features 220.

In certain aspects, V2X features 220 extracted by V2X feature extraction component 218 are stored in an (A x B) matrix (e.g., a matrix with A rows and B columns). For example, in cases where first V2X messages 212 include an amount A of V2X messages, the table may include A rows, where each row is associated with a first V2X message 212. Further, the table may include an amount B columns, where each column is associated with a V2X feature 220 associated with the first V2X message 212 associated with the respective row where the V2X feature 220 is situated in the matrix.

In certain aspects, the V2X features 220 are used by an initial grid generation component 222 to generate an initial 2D grid 224. In other words, the initial 2D grid 224 may be generated based on V2X features 220. The initial 2D grid 224 may have (W x H) dimensions. In certain aspects, the dimensions (W x H) may be based on a communication range (e.g., for V2X communications) of ego vehicle 210. In certain aspects, the dimensions (W x H) may be based on one or more performance limitations of a neural network (e.g., second neural network 234, described in detail below) configured to project V2X features 220 from a V2X feature space to a BEV space. In certain aspects, the dimensions (W x H) may be based on a (maximum) sensor range of at least one sensor associated with ego vehicle 210. In certain aspects, the center of the initial 2D grid 224 may be associated with a center of ego vehicle 210

In addition to using the V2X features 220 to generate the initial 2D grid 224, in certain aspects, the V2X features 220 may be processed by a first neural network 226 to output a BEV query value 228. For example, based on at least V2X coordinates (e.g., BSM coordinates) included in V2X features 220, first neural network 226 may determine the BEV query value 228. BEV query value 228 may comprise a BEV query value among M BEV query values that may be output by first neural network 226. Each BEV query value, of the M BEV query values, may be associated with a particular masking pattern. Put differently, each BEV query value may be associated with a 2D grid/BEV grid with a particular masking pattern (e.g., having empty cells and/or filled cells). For example, a first BEV query value may be associated with masking a right side of initial 2D grid 224, a second BEV query value may be associated with masking a left side of initial 2D grid 224, a third BEV query value may be associated with no masking of the initial 2D grid 224, etc. In certain aspects, the first neural network 226 comprises a multilayer perception (MLP), which is a type of artificial neural network (ANN) that includes multiple layers of interconnected artificial neurons, called nodes or units. An MLP is a feedforward neural network, meaning that, when making predictions, information flows in one direction, from input to output.

A masking component 230 may use BEV query value 228 to mask a portion (if any) of initial 2D grid 224. For example, as indicated above, BEV query value 228 is associated with a 2D grid/BEV grid having empty cells and/or filled cells. Each filled cell may include a value. A value of “0” included in a filled cell may indicate that there are no object(s) at a location associated with the filled cell. Empty cells, or cells without a value, may be filled by a neural network, such as a BEV encoder. For example, a BEV encoder may assign a value of “O” to the empty cell when no object is located at a location associated with the cell, and assign a value of “1” to the empty cell when at least one object is located at the location associated with the cell.

In this example, V2X features 220 may indicate that vehicles 202 are located on a left side of ego vehicle 210 in the scene. Thus, first neural network may output a BEV query value 228 that is associated with masking a right side of initial 2D grid 224, and keeping data on a left side of initial 2D grid 224. Masking component 230 may determine that BEV query value 228 is associated with masking the right side of initial 2D grid 224, and thus, mask the right side of initial 2D grid 224 (e.g., mask the initial 2D grid 224 based on BEV query value 228). Masking initial 2D grid 224 may generate an output 2D grid 232. Output 2D grid 232 may include data in less cells, such that less cells need to be processed by a second neural network 234.

Specifically, second neural network 234 may process the output 2D grid 232 to generate the BEV representation 236. Thus, generating the BEV representation 236 may involve projecting V2X features 220, associated with V2X messages 212 from vehicles 202, from the V2X space to the BEV space. In certain aspects, the second neural network 234 comprises a BEV encoder.

In certain aspects, the second neural network 234 may further process sensor data from sensor(s) associated with ego vehicle 210 to provide a more comprehensive and/or accurate view of a scene (e.g., rather than generating the BEV representation 236 on only V2X messages 212 from vehicles 202). Thus, in certain aspects, second neural network 234 may process the output 2D grid 232 and sensor data obtained from sensor(s) associated with ego vehicle 210 to generated BEV representation 236. The BEV representation 236 may additionally integrate sensor data from such sensors to provide a more comprehensive and/or accurate view of a scene.

BEV representation 236 may include BEV features associated with one or more objects in the scene (e.g., the 2D scene or the 3D scene), such as surrounding ego vehicle 210. As described in detail herein, “BEV features” may refer to particular attributes or states of the object(s) in the scene that are transformed and mapped into a BEV grid. An example BEV feature may include a location of an object in the scene, expressed as a set of x and y coordinates corresponding to one or more cells in the BEV grid. Other example BEV features may include values entered into the cells of the BEV grid, such as (1) a value entered for a respective cell indicating the existence of an object in the cell in the BEV grid, (2) a value indicating the probability of an object existing in a respective cell in the BEV grid, (3) a value indicating the class of an object associated with a respective cell in the BEV grid, etc.

In certain aspects, an object detection component 238 of ego vehicle 210 may use the BEV representation 236 to detect one or more objects in the scene. In certain aspects, the detected object(s) may include an object that is outside of a sensor range of a sensor associated with ego vehicle 210. More specifically, the object may include a NLOS object that the ego vehicle 210 may not have been able to detect if not for using V2X message 212 data from vehicles 202 (e.g., such as when relying solely on sensor data from sensor(s) associated with ego vehicle 210).

### Aspects Related to V2X Message Processing

FIG. 3 depicts an example workflow 300 for V2X message processing. In certain aspects, workflow 300 may be performed by a processing component 314, which is an example of processing component 214 depicted and described with respect to FIG. 2, which was used to generate second V2X messages 216 from first V2X messages 212.

For example, workflow 300 may be used to process an example first V2X message 302. The first V2X message 302 may comprise a single first V2X message 212 depicted and described with respect to FIG. 2. In this example, first V2X message 302 includes information about an object in a scene (e.g., surrounding an ego vehicle, such as ego vehicle 210 of FIG. 2) during a first time period (e.g., time t1). The object is Vehicle 1. The information about the object included in first V2X message 302 includes identification data (e.g., “Vehicle 1”), cryptographic data (e.g., “digital signature”), and first state data (e.g. position and classification) associated with the object (e.g., Vehicle 1) at time t1. In certain other aspects, more or less, or different, data may be included in a V2X message.

In workflow 300, processing component 304 begins processing first V2X message 302 by performing trimming. Trimming may include removing cryptographic data and/or identification data from first V2X message 302. For example, identification data (e.g., “Vehicle 1”) and cryptographic data (e.g., “digital signature”) may be removed from first V2X message 302 to generate an intermediate V2X message 306.

Workflow 300 then proceeds with processing component 304 transforming intermediate V2X message 306 in time. Transforming intermediate V2X message 306 in time may include predicting second state data for the object (e.g., Vehicle 1) for a second time period (e.g., time T, which represents the time of interest for a BEV representation that may be generated). In certain aspects, a third neural network 308 is used to process the first state data (e.g., position and classification) included in intermediate V2X message 306 (e.g., which is associated with the object in the scene during the first time period, time t1) to predict second state data associated with the object in the scene during the second time period, time T. For example, the predicted second state data may include information about a position of the object in the scene at time T, instead of at time t. In certain aspects, the third neural network 308 is a time series model, such as a long short-term memory (LSTM) network. The predicated second state data, associated with the object during the second time period, time T, may be included in another intermediate V2X message 310.

Workflow 300 then proceeds with processing component 304 transforming intermediate V2X message 310 in space. Transforming intermediate V2X message 310 in space may include aligning, in space, the information included in intermediate V2X message 310 with a position of the ego vehicle during the second time period (e.g., at time T) (e.g., shown at 314 in FIG. 3). For example, transforming intermediate V2X message 310 in space may include generating third state data based on the second state data, included in intermediate V2X message 310, and the position of the ego vehicle during the second time period. The third state data may include at least a relative position (R-position) of the object (e.g., Vehicle 1) in the scene with respect to the position of the ego vehicle during the second time period. For example, the position of the ego vehicle during the second time period may be the origin point of the spatial frame such that the position of the object is determined relative to the ego vehicle. In certain aspects, the third state data may be used to generate a second V2X message 316, which is an example of a single second V2X message 216 in FIG. 2.

In certain aspects, a function 312 (e.g., F( . . . )) may be used to determine the third state data, and more specifically, the relative position of the object (e.g., Vehicle 1) with respect to the position of the ego vehicle during the second time period (e.g., at time T).

As an illustrative example, intermediate V2X message 310 may include information about a location an object in the scene (e.g., a V2X object), where the location is given as Geodetic/global positioning system (GPS)/World Geodetic System 1984 (WGS-84) coordinates. Specifically, the coordinates of the object may be provided as latitude, longitude, and height, where the latitude and longitude are provided in degrees. The object's coordinates included in intermediate V2X message 310 may be absolute and thus, not relative to the ego vehicle (e.g., the center of original may not be the ego vehicle). Accordingly, an example function 312, F( . . . ), may be used to determine the relative Cartesian coordinates (e.g., x, y, z) and/or relative spherical coordinates of the object with respect to the ego vehicle. For example, the function 312, F( . . . ), may involve performing (1) a first conversion from Global Navigation Satellite System (GNSS) to Earth-centered, Earth-fixed (ECEF) coordinates on the ego vehicle GPS position and (2) a second GPS to ECEF transformation on the intermediate V2X message 310 object data. Next, (3) the relative Cartesian position of the object with respect to the ego vehicle may be computed based on the ECEF position of the ego vehicle and the ECEF position of the object. For example:

$${X}_{Relative Object} = {X}_{ECEF of Object} - {X}_{ECEF of Ego Vehicle}$$

$${Y}_{Relative Object} = {Y}_{ECEF of Object} - {Y}_{ECEF of Ego Vehicle}$$

$${Z}_{Relative Object} = {Z}_{ECEF of Object} - {Z}_{ECEF of Ego Vehicle}$$

Regarding the relative heading, if both the ego vehicle and the object are facing the same direction, the degree difference may be computed, such as when facing magnetic North.

Workflow 300 then proceeds with processing component 304 updating a tracker 318 with second V2X message 316, and further, in some cases, filtering V2X messages included in the tracker 318. For example, the tracker 318 may be a data frame including multiple second V2X messages (e.g., first V2X messages that have been processed by processing component 304), which may eventually be used to generate a BEV representation (e.g., such as BEV representation 236 in FIG. 2). In certain aspects, updating the tracker 318 with second V2X message 316 may include adding the second V2X message 316 to the tracker 318 (e.g., the data frame). In certain aspects, updating the tracker 318 with the second V2X message 316 may include replacing an existing V2X message, associated with the object and included in the tracker 318 (e.g., was previously added to the tracker for the object), with the second V2X message 316. For example, a V2X message included in the tracker including state data for the object for a third time period (e.g., time T−1) may be replaced with second V2X message 316 to update the state data stored for the object, such that the state data stores is associated with the second time period (e.g., time T). In certain aspects, updating the tracker 318 may be based on a frequency of a sensor associated with the ego vehicle. In certain aspects, updating the tracker 318 may be based on the needs of the system described herein for the generation of BEV representations from multi-vehicle sensor data. For example, the tracker 318 may be updated such that the BEV representation generated provides an updated view every 100 milliseconds (ms).

In certain aspects, second V2X messages included in tracker 318 may need to be filtered. For example, filtering may be performed by processing component 304 to remove second V2X message(s) included in tracker 318 that include information (e.g., state data) for objects that are (1) more than a first threshold distance away from the ego vehicle, during the second time period (e.g., time T), in a vertical direction and/or (2) more than a second threshold distance away from the ego vehicle, during the second time period (e.g., time T), in a horizontal direction. The first and second threshold distances are examples of threshold distance(s) 330 shown in FIG. 3. The first threshold distance may be used for filtering by processing component 304 to remove second V2X message(s) associated with vehicle(s) not located on a same road level as the ego vehicle during the second time period (e.g., vehicle(s) located on a bridge above the ego vehicle during the second time period, etc.). The second threshold distance may be used for filtering by processing component 304 to remove second V2X message(s) associated with vehicle(s) that may be located too far away from the ego vehicle during the second time period.

In certain aspects, an ML model may be trained on a dataset to learn the threshold distance(s) 330 (e.g., such as the first threshold distance and/or the second threshold distance). For example, a dataset of V2X messages (e.g., such as a public or a private dataset) representing V2X objects with (x, y, z) coordinates may be used for training. Specifically, supervised training may be used to train the ML model to determine which V2X messages, associated with which V2X objects, in the dataset are at a same road level (e.g., have a same z-value) as an ego vehicle. In certain aspects, the threshold distance(s) 330 may be configured, such as configured by a user.

Workflow 300 then proceeds with processing component 304 padding tracker 318 to create tracker 322. For example, tracker 318 (e.g., the data frame) may store up to S second V2X messages (e.g., where S is an integer greater than zero). If the number of second V2X messages included in tracker 318 is equal to S, then padding may not be needed. However, if the number of second V2X messages included in tracker 318 is less than S, processing component 304 may perform padding to add one or more dummy second V2X messages to tracker 318, and thus generate tracker 320. A dummy second V2X message may include a V2X message with its fields set to zero, such as shown in FIG. 3.

The second V2X messages included in tracker 318, or tracker 320, may then be used by a V2X feature extraction component 324, which is an example of the V2X feature extraction component 218 depicted and described above with respect to FIG. 2. For example, V2X feature extraction component 324 may be used to extract V2X features from the second V2X messages included in tracker 318, or tracker 320.

Although FIG. 3 described processing component 304 processing the first V2X message based on performing trimming, transformation in time, transformation in space, tracker updating, filtering, and padding, in certain other aspects, “processing” performed by processing component 304 may include only one or more of the aforementioned steps (e.g., only trimming and transformation in time and space), instead of all of the aforementioned steps, and/or may include one or more additional steps.

### Example Artificial Intelligence (AI) System for Object Detection

Certain aspects described herein may be implemented, at least in part, using some form of AI, e.g., the process of using an ML model to infer or predict output data based on input data. An example ML model may include a mathematical representation of one or more relationships among various objects to provide an output representing one or more predictions or inferences. Once an ML model has been trained, the ML model may be deployed to process data that may be similar to, or associated with, all or part of the training data and provide an output representing one or more predictions or inferences based on the input data.

ML is often characterized in terms of types of learning that generate specific types of learned models that perform specific types of tasks. For example, different types of machine learning include supervised learning, unsupervised learning, semi-supervised learning, and reinforcement learning.

Supervised learning algorithms generally model relationships and dependencies between input features (e.g., a feature vector) and one or more target outputs. Supervised learning uses labeled training data, which are data including one or more inputs and a desired output. Supervised learning may be used to train models to perform tasks like classification, where the goal is to predict discrete values, or regression, where the goal is to predict continuous values. Some example supervised learning algorithms include nearest neighbor, naive Bayes, decision trees, linear regression, support vector machines (SVMs), and artificial neural networks (ANNs).

Unsupervised learning algorithms work on unlabeled input data and train models that take an input and transform it into an output to solve a practical problem. Examples of unsupervised learning tasks are clustering, where the output of the model may be a cluster identification, dimensionality reduction, where the output of the model is an output feature vector that has fewer features than the input feature vector, and outlier detection, where the output of the model is a value indicating how the input is different from a typical example in the dataset. An example unsupervised learning algorithm is k-Means.

Semi-supervised learning algorithms work on datasets containing both labeled and unlabeled examples, where often the quantity of unlabeled examples is much higher than the number of labeled examples. However, the goal of semi-supervised learning is that of supervised learning. Often, a semi-supervised model includes a model trained to produce pseudo-labels for unlabeled data that is then combined with the labeled data to train a second classifier that leverages the higher quantity of overall training data to improve task performance.

Reinforcement Learning algorithms use observations gathered by an agent from an interaction with an environment to take actions that may maximize a reward or minimize a risk. Reinforcement learning is a continuous and iterative process in which the agent learns from its experiences with the environment until it explores, for example, a full range of possible states. An example type of reinforcement learning algorithm is an adversarial network. Reinforcement learning may be particularly beneficial when used to improve or attempt to optimize a behavior of a model deployed in a dynamically changing environment, such as an object detection system in autonomous driving.

Aspects described herein may describe the performance of certain tasks and the technical solution of various technical problems by application of a specific type of ML model, such as an ANN. It should be understood, however, that other type(s) of AI models may be used in addition to or instead of an ANN. An ML model may be an example of an AI model, and any suitable AI model may be used in addition to or instead of any of the ML models described herein. Hence, unless expressly recited, subject matter regarding an ML model is not necessarily intended to be limited to just an ANN solution or machine learning. Further, it should be understood that, unless otherwise specifically stated, terms such “AI model,” “ML model,” “AI/ML model,” “trained ML model,” and the like are intended to be interchangeable.

### Example AI System for Object Detection

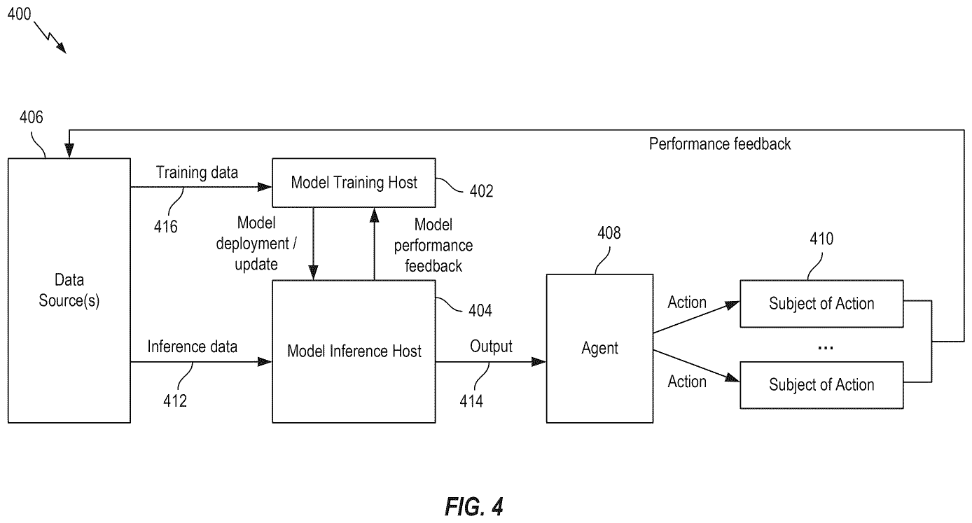

FIG. 4 is a diagram illustrating an example AI architecture 400 that may be used to implement the machine learning models and object detection techniques described in this disclosure, including use of dynamic grid(s). As illustrated, the architecture 400 includes multiple logical entities, such as a model training host 402 for training the machine learning models for object detection, a model inference host 404 for running inference using the trained models for object detection and tracking, data source(s) 406 providing training and inference data, and an agent 808 that utilizes the models' output. This AI architecture could be used to enable the disclosed object detection techniques in various machine learning applications.

The model inference host 404, in the architecture 400, is configured to run the trained machine learning models based on inference data 412 provided by data source(s) 406. The model inference host 404 may produce an output 414 (e.g., detected objects, scene representations) based on the inference data 412, which is then provided as input to the agent 408. The model inference host 404 utilizes the object detection techniques described in this disclosure to generate accurate object detections and scene representations, enabling downstream tasks such as object tracking and motion planning.

The agent 408 may be an element or entity that utilizes the output of the machine learning models hosted by the model inference host 404. The agent 408 could be a software component, a hardware accelerator, or a system that leverages the detected objects and scene representations produced by the models for various downstream tasks such as autonomous navigation, collision avoidance, or driver assistance systems.

For example, if the output 414 from the model inference host 404 includes detected objects with their positions and velocities, the agent 408 may be an object tracking system that uses this information to maintain consistent object identities over time. As another example, if the output 414 is a comprehensive scene representation produced using V2X message data, such as by fusing data from multiple V2X messages associated with multiple vehicles, the agent 408 may be an object detection module and/or a motion planning module that generates safe and efficient trajectories for a vehicle.

After receiving the output 414 from the model inference host 404, the agent 408 may determine how to utilize it. For instance, if the agent 408 is an object tracking system, it may use the detected objects to update their trajectories and predict future positions. If the agent 408 decides to use the output 414, it may apply it to the subject of the action 410, which represents the data being processed or enhanced. In the object tracking example, the subject of action 410 would be the sequence of detected objects over time. In some cases, the agent 408 and subject of action 410 may be tightly integrated.

The data sources 406 may be configured to collect data used as training data 816 for the model training host 402 to train the object detection machine learning models. The data sources 406 may also provide inference data 412 to the model inference host 404. This data could come from various entities and may include the subject of action 410. For example, for training an object detection model, the data sources 406 may collect synchronized sensor data from cameras, LiDAR, radar, and other sensors mounted on vehicles. The model training host 402 can then monitor the models' performance on this data to determine if retraining or fine-tuning with the object detection model is necessary to improve accuracy. In some cases, the agent 408 and the subject of action 410 are the same entity.

The data sources 406 may be configured for collecting data that is used as training data 416 for training the object detection machine learning models with dynamic grids. The data sources 406 may also provide inference data 412 (also referred to as input data) for feeding the trained models during inference. In particular, the data sources 406 may collect data relevant to the object detection task at hand, such as sensor data from various modalities, grid parameters, object location information, or the like. This data may come from various sources, including the subject of action 410, which represents the data being processed by the models. The collected data is provided to the model training host 402 for training and fine-tuning the object detection model. For example, after the subject of action 410 (e.g., sensor data with known object positions) is processed by the models, the output 414 (e.g., detected objects and scene representations) may be compared to ground truth data to evaluate the models' performance. If the output 414 is not sufficiently accurate, this performance feedback may be used by the model training host 802 to further train the model using the disclosed object detection techniques, aiming to improve detection accuracy and robustness. The updated models may then be deployed to the model inference host 404.

In certain aspects, the model training host 402 may be deployed at or with the same or a different entity than that in which the model inference host 404 is deployed. For example, to offload model training processing, which can impact the performance of the model inference host 404, the model training host 402 may be deployed at a model server as further described herein. Further, in some cases, training and/or inference may be distributed amongst devices in a decentralized or federated fashion.

In some aspects, object detection ML models, utilizing BEV representations generated based on V2X message data, are deployed at or on a computing device for enhancing the performance of object detection and tracking tasks. More specifically, a model inference host, such as model inference host 404 in FIG. 4, may be deployed at or on the computing device for running the object detection model to improve detection accuracy and object tracking in dynamic environments.

In some other aspects, object detection ML models are deployed at or on an embedded system or mobile device for enabling efficient on-device inference. More specifically, a model inference host, such as model inference host 404 in FIG. 4, may be deployed at or on the embedded system or mobile device for running the models to obtain high-quality scene representations while meeting resource constraints.

### Example AI Model

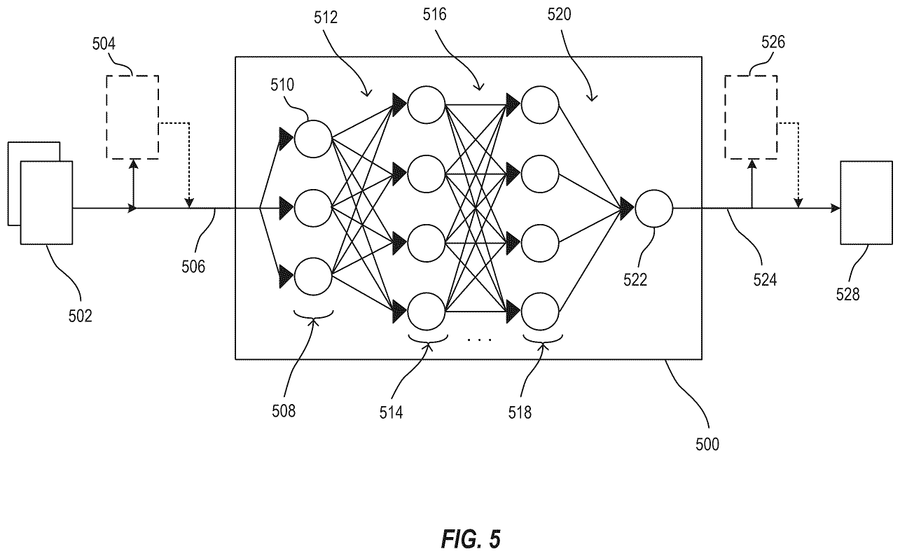

FIG. 5 is an illustrative block diagram of an example artificial neural network (ANN) 500 that can be used to implement the object detection techniques described in this disclosure.

ANN 500 may receive input data 506, which may include one or more bits of data 502, pre-processed data output from pre-processor 504 (optional), or some combination thereof. Here, data 502 may include sensor data from various modalities (e.g., cameras, LiDAR, radar), grid parameters, and object location information. In some aspects, data 502 may include training data from multiple domains for domain generalization, inference data from a specific domain for domain adaptation, or the like, e.g., depending on the stage of development and/or deployment of ANN 500. Pre-processor 504 may, for example, process all or a portion of data 502 to synchronize sensor inputs, apply calibration parameters, or normalize the data. In some implementations, pre-processor 504 may add additional data to data 502, such as time stamps or sensor metadata.

ANN 500 includes at least one first layer 508 of artificial neurons 510 (e.g., perceptrons) to process input data 506 and provide resulting first layer output data via edges 512 to at least a portion of at least one second layer 514. Second layer 514 processes data received via edges 512 and provides second layer output data via edges 516 to at least a portion of at least one third layer 518. Third layer 518 processes data received via edges 516 and provides third layer output data via edges 520 to at least a portion of a final layer 522 including one or more neurons to provide output data 524. All or part of output data 524 may be further processed in some manner by (optional) post-processor 526. Thus, in certain examples, ANN 500 may provide output data 528 that is based on output data 524, post-processed data output from post-processor 526, or some combination thereof. Post-processor 526 may be included within ANN 500 in some other implementations. Post-processor 526 may, for example, process all or a portion of output data 524 which may result in output data 1028 being different, at least in part, to output data 524, e.g., as result of data being changed, replaced, deleted, etc. In some implementations, post-processor 526 may be configured to add additional data to output data 524, such as domain-specific post-processing or adaptation. In this example, second layer 514 and third layer 518 represent intermediate or hidden layers that may be arranged in a hierarchical or other like structure. Although not explicitly shown, there may be one or more further intermediate layers between the second layer 514 and the third layer 518.

The structure and training of artificial neurons 510 in the various layers may be tailored to specific requirements of an application, such as multi-grid sensor fusion for object detection and tracking. Within a given layer of an ANN, some or all of the neurons may be configured to process information provided to the layer and output corresponding transformed information from the layer. For example, transformed information from a layer may represent a weighted sum of the input information associated with or otherwise based on a non-linear activation function or other activation function used to “activate” artificial neurons of a next layer. Artificial neurons in such a layer may be activated by or be responsive to weights and biases that may be adjusted during a training process to learn domain-invariant representations. Weights of the various artificial neurons may act as parameters to control a strength of connections between layers or artificial neurons, while biases may act as parameters to control a direction of connections between the layers or artificial neurons. An activation function may select or determine whether an artificial neuron transmits its output to the next layer or not in response to its received data. Different activation functions may be used to model different types of non-linear relationships. By introducing non-linearity into an ML model, an activation function allows the ML model to “learn” complex patterns and relationships in the input data (e.g., 412 in FIG. 4) across different domains. Some non-exhaustive example activation functions include a linear function, binary step function, sigmoid, hyperbolic tangent (tanh), a rectified linear unit (ReLU) and variants, exponential linear unit (ELU), Swish, Softmax, and others.

Design tools (such as computer applications, programs, etc.) may be used to select appropriate structures for ANN 500 and a number of layers and a number of artificial neurons in each layer, as well as selecting activation functions, a loss function, training processes, etc., to enable domain generalization and adaptation. Once an initial model has been designed, training of the model may be conducted using training data from multiple domains. Training data may include one or more datasets within which ANN 5000 may detect, determine, identify or ascertain patterns that are consistent across domains. Training data may represent various types of information, including written, visual, audio, environmental context, operational properties, etc., from different domains. During training, parameters of artificial neurons 510 may be changed, such as to minimize or otherwise reduce a loss function or a cost function that measures the model's performance across domains. A training process may be repeated multiple times to fine-tune ANN 500 with each iteration to improve its domain generalization capability.

Various ANN model structures are available for consideration in the context of domain generalization and adaptation. For example, in a feedforward ANN structure each artificial neuron 510 in a layer receives information from the previous layer and likewise produces information for the next layer. In a convolutional ANN structure, some layers may be organized into filters that extract domain-invariant features from data (e.g., training data and/or input data). In a recurrent ANN structure, some layers may have connections that allow for processing of data across time, such as for processing information having a temporal structure, such as time series data forecasting across domains.

In an autoencoder ANN structure, compact representations of data may be processed and the model trained to predict or potentially reconstruct original data from a reduced set of features that capture domain-invariant patterns. An autoencoder ANN structure may be useful for tasks related to dimensionality reduction and data compression in a domain-agnostic manner.

A generative adversarial ANN structure may include a generator ANN and a discriminator ANN that are trained to compete with each other. Generative-adversarial networks (GANs) are ANN structures that may be useful for tasks relating to generating synthetic data or improving the performance of other models in a domain-adaptive way. For example, a GAN could be used to generate realistic training data for a new domain to improve the domain generalization of another model.

A transformer ANN structure makes use of attention mechanisms that may enable the model to process input sequences in a parallel and efficient manner while capturing long-range dependencies and domain-specific patterns. An attention mechanism allows the model to focus on different parts of the input sequence at different times based on their relevance to the task and domain. Attention mechanisms may be implemented using a series of layers known as attention layers to compute, calculate, determine or select weighted sums of input features based on a similarity between different elements of the input sequence. A transformer ANN structure may include a series of feedforward ANN layers that may learn non-linear relationships between the input and output sequences in a domain-adaptive way. The output of a transformer ANN structure may be obtained by applying a linear transformation to the output of a final attention layer. A transformer ANN structure may be of particular use for tasks that involve sequence modeling, or other like processing, across different domains.

Another example type of ANN structure, is a model with one or more invertible layers. Models of this type may be inverted or “unwrapped” to reveal the input data that was used to generate the output of a layer, which can be useful for understanding how the model adapts to different domains.

Other example types of ANN model structures that can be used for domain generalization and adaptation include fully connected neural networks (FCNNs) and long short-term memory (LSTM) networks.

ANN 500 or other ML models may be implemented in various types of processing circuits along with memory and applicable instructions therein, for example, as described herein with respect to FIG. 4. For example, general-purpose hardware circuits, such as, such as one or more central processing units (CPUs) and one or more graphics processing units (GPUs) may be employed to implement a model. One or more ML accelerators, such as tensor processing units (TPUs), embedded neural processing units (eNPUs), or other special-purpose processors, and/or field-programmable gate arrays (FPGAs), application-specific integrated circuits (ASICs), or the like also may be employed. Various programming tools are available for developing ANN models that can perform object detection.

### Example Methods for Object Detection

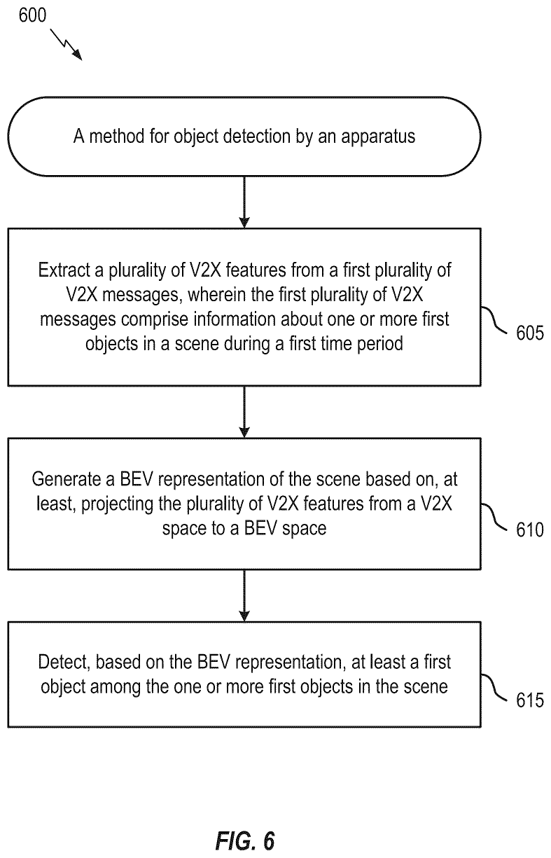

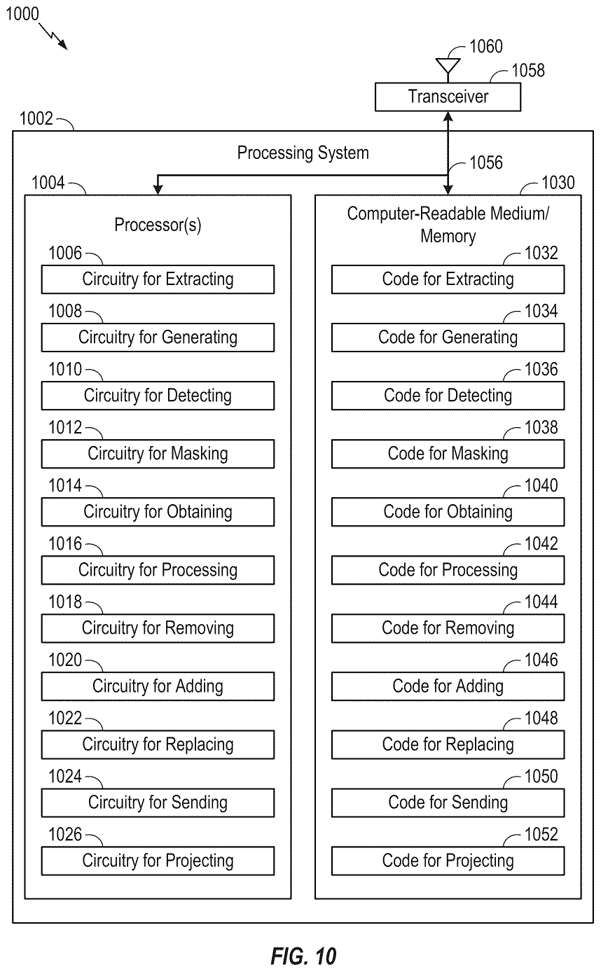

FIG. 6 depicts an example method 600 for object detection. In certain aspects, method 600, or any aspect related to it, may be performed by an apparatus, such as apparatus 1000 of FIG. 10, which includes various components operable, configured, or adapted to perform the method 600.

Method 600 begins at block 605 with extracting a plurality of V2X features from a first plurality of V2X messages, wherein the first plurality of V2X messages comprise information about one or more first objects in a scene during a first time period.

Method 600 then proceeds to block 610 with generating a BEV representation of the scene based on, at least, projecting the plurality of V2X features from a V2X space to a BEV space.

Method 600 then proceeds to block 615 with detecting, based on the BEV representation, at least a first object among the one or more first objects in the scene.

In some aspects, block 610 includes: processing, by a first neural network, the plurality of V2X features and output a BEV query value; generating an initial 2D grid based on the plurality of V2X features; masking the initial 2D grid based on the BEV query value to generate an output 2D grid; and processing, by a second neural network, the output 2D grid to generate the BEV representation.

In some aspects, the first neural network comprises a multilayer perceptron.

In some aspects, a center of the initial 2D grid is associated with a center of the apparatus; and a size of the initial 2D grid is based on at least one of: a communication range of the apparatus; one or more performance limitations of the second neural network; or a sensor range of at least one sensor associated with the apparatus.

In some aspects, method 600 further includes obtaining sensor data from one or more sensors associated with the apparatus, wherein block 610 includes processing, by the second neural network, the output 2D grid and the sensor data to generate the BEV representation.

In some aspects, method 600 further includes processing a second plurality of V2X messages to generate the first plurality of V2X messages, wherein the second plurality of V2X messages comprise information about the one or more first objects in the scene during a second time period.

In some aspects, the second plurality of V2X messages comprise at least one of: a BSM; or a CAM.

In some aspects, the second plurality of V2X messages comprise a first V2X message comprising information about the first object in the scene during the second time period; and the information about the first object comprises first state data and at least one of: cryptographic data; or identification data.

In some aspects, the information about the first object comprises at least one of the cryptographic data or the identification data; and processing the second plurality of V2X messages to generate the first plurality of V2X messages comprises removing at least one of the cryptographic data or the identification data from the first V2X message.

In some aspects, processing the second plurality of V2X messages to generate the first plurality of V2X messages, comprises: processing, by a neural network, the first state data associated with the first object in the scene during the second time period to predict second state data associated with the first object in the scene during the first time period; and generating a first intermediate V2X message comprising the second state data.

In some aspects, the neural network comprises a LSTM network.

In some aspects, the second state data comprises a position of the first object in the scene during the first time period; and processing the second plurality of V2X messages to generate the first plurality of V2X messages, comprises: generating third state data based on the second state data and a position of the apparatus in the scene during the first time period, the third state data comprising at least a relative position of the first object in the scene with respect to the position of the apparatus during the first time period; and generating a second intermediate V2X message comprising the third state data.

In some aspects, processing the second plurality of V2X messages to generate the first plurality of V2X messages, comprises: adding the second intermediate V2X message to a data frame comprising a plurality of intermediate V2X messages; or replacing an intermediate V2X message associated with the first object in the data frame with the second intermediate V2X message.

In some aspects, processing the second plurality of V2X messages to generate the first plurality of V2X messages, comprises removing one or more intermediate V2X messages of the plurality of intermediate V2X messages from the data frame based on at least one of: a threshold distance from the position of the apparatus in a vertical direction; or a threshold distance from the position of the apparatus in a horizontal direction.

In some aspects, processing the second plurality of V2X messages to generate the first plurality of V2X messages, comprises: adding one or more dummy intermediate V2X messages to the data frame, wherein the plurality of V2X messages and the one or more dummy intermediate V2X messages in the data frame comprise the first plurality of V2X messages.

In some aspects, block 605 includes extracting, by a convolutional neural network or a transformer, the plurality of V2X features from the first plurality of V2X messages.

In some aspects, the plurality of V2X features comprise at least one of: first data included in the first plurality of V2X messages; or second data computed based on the first data included in the first plurality of V2X messages.

In some aspects, the first plurality of V2X messages comprise at least one of: a BSM; or a CAM.

In some aspect, method 600, or any aspect related to it, may be performed by an apparatus, such as apparatus 1000 of FIG. 10, which includes various components operable, configured, or adapted to perform the method 600. Apparatus 1000 is described below in further detail.

Note that FIG. 6 is just one example of a method, and other methods including fewer, additional, or alternative operations are possible consistent with this disclosure.

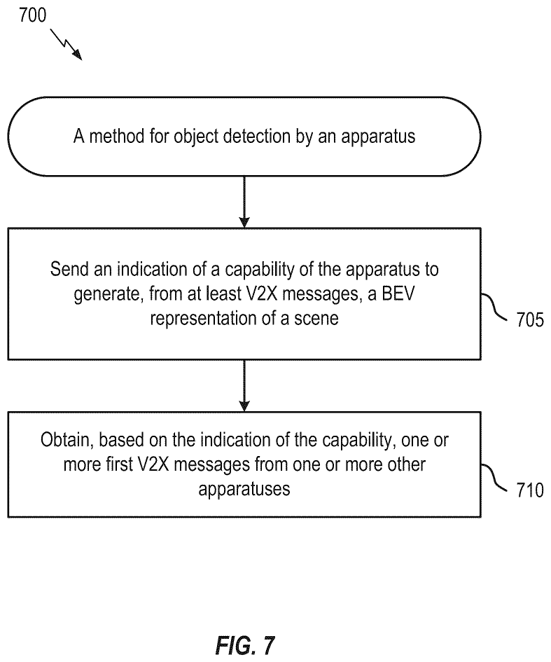

FIG. 7 depicts an example method 700 for object detection. In certain aspects, method 700, or any aspect related to it, may be performed by an apparatus, such as apparatus 1000 of FIG. 10, which includes various components operable, configured, or adapted to perform the method 700.

Method 700 begins at block 705 with sending an indication of a capability of the apparatus to generate, from at least V2X messages, a BEV representation of a scene.

Method 700 then proceeds to block 710 with obtaining, based on the indication of the capability, one or more first V2X messages from one or more other apparatuses.

In some aspects, the one or more first V2X messages comprise information about one or more first objects in the scene during a first time period; and the method 700 further comprises: processing the one or more first V2X messages to generate one or more second V2X messages, the one or more second V2X messages comprising information about the one or more first objects in the scene during a second time period; extracting a plurality of V2X features from the one or more second V2X messages; generating the BEV representation of the scene based on, at least, projecting the plurality of V2X features from a V2X space to a BEV space; and detecting, based on the BEV representation, at least a first object among the one or more first objects in the scene.

In some aspects, generating the BEV representation of the scene based on, at least, projecting the plurality of V2X features from the V2X space to the BEV space, comprises: processing, by a first neural network, the plurality of V2X features and output a BEV query value; generating an initial 2D grid based on the plurality of V2X features; masking the initial 2D grid based on the BEV query value to generate an output 2D grid; and processing, by a second neural network, the output 2D grid to generate the BEV representation.

In some aspects, the first neural network comprises a multilayer perceptron.

In some aspects, a center of the initial 2D grid is associated with a center of the apparatus; and a size of the initial 2D grid is based on at least one of: a communication range of the apparatus; one or more performance limitations of the second neural network; or a sensor range of at least one sensor associated with the apparatus.

In some aspects, method 700 further includes obtaining sensor data from one or more sensors associated with the apparatus, wherein generating the BEV representation comprises processing, by the second neural network, the output 2D grid and the sensor data to generate the BEV representation.

In some aspects, at least one of the one or more first V2X messages or the one or more second V2X messages comprise at least one of: a BSM; or a CAM.

In some aspects, the one or more first V2X messages comprise a first V2X message comprising information about the first object in the scene during the first time period; and the information about the first object comprises first state data and at least one of: cryptographic data; or identification data.

In some aspects, processing the one or more first V2X messages to generate the one or more second V2X messages comprises removing at least one of the cryptographic data or the identification data from the first V2X message.

In some aspects, processing the one or more first V2X messages to generate the one or more second V2X messages, comprises: processing, by a neural network, the first state data associated with the first object in the scene during the first time period to predict second state data associated with the first object in the scene during the second time period; and generating a first intermediate V2X message comprising the second state data.

In some aspects, the neural network comprises a LSTM network.

In some aspects, the second state data comprises a position of the first object in the scene during the second time period; and processing the one or more first V2X messages to generate the one or more second V2X messages, comprises: generating third state data based on the second state data and a position of the apparatus in the scene during the second time period, the third state data comprising at least a relative position of the first object in the scene with respect to the position of the apparatus during the second time period; and generating a second intermediate V2X message comprising the third state data.

In some aspects, the one or more second V2X messages comprise a plurality of second V2X messages; and processing the one or more first V2X messages to generate the plurality of second V2X messages, comprises: adding the second intermediate V2X message to a data frame comprising a plurality of intermediate V2X messages; or replacing an intermediate V2X message associated with the first object in the data frame with the second intermediate V2X message.

In some aspects, processing the one or more first V2X messages to generate the plurality of second V2X messages comprises removing one or more intermediate V2X messages of the plurality of intermediate V2X messages from the data frame based on at least one of: a threshold distance from the position of the apparatus in a vertical direction; or a threshold distance from the position of the apparatus in a horizontal direction.

In some aspects, processing the one or more first V2X messages to generate the plurality of second V2X messages, comprises: adding one or more dummy intermediate V2X messages to the data frame, wherein the plurality of V2X messages and the one or more dummy intermediate V2X messages in the data frame comprise the plurality of second V2X messages.

In some aspects, extracting the plurality of V2X features comprises extracting, by a convolutional neural network or a transformer, the plurality of V2X features from the one or more second V2X messages.

In some aspects, the plurality of V2X features comprise at least one of: first data included in the one or more second V2X messages; or second data computed based on the first data included in the one or more V2X messages.

In some aspect, method 700, or any aspect related to it, may be performed by an apparatus, such as apparatus 1000 of FIG. 10, which includes various components operable, configured, or adapted to perform the method 700. Apparatus 1000 is described below in further detail.

Note that FIG. 7 is just one example of a method, and other methods including fewer, additional, or alternative operations are possible consistent with this disclosure.

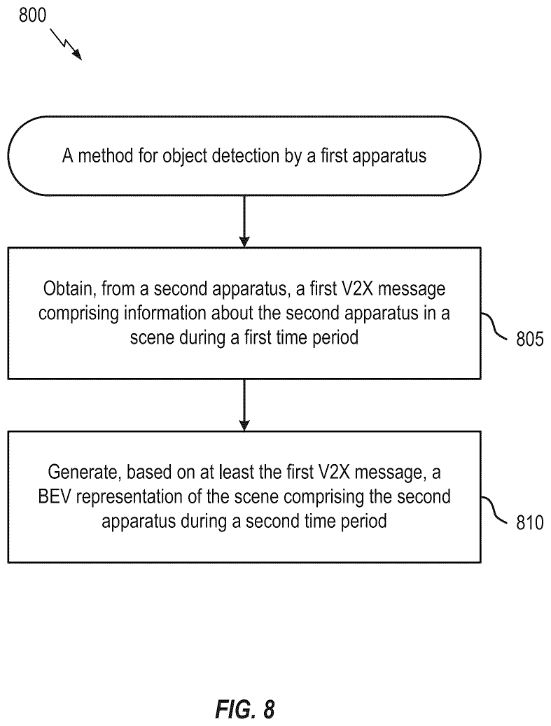

FIG. 8 depicts an example method 800 for object detection. In certain aspects, method 800, or any aspect related to it, may be performed by an apparatus, such as apparatus 1000 of FIG. 10, which includes various components operable, configured, or adapted to perform the method 800.

Method 800 begins at block 805 with obtaining, from a second apparatus, a first V2X message comprising information about the second apparatus in a scene during a first time period.

Method 800 then proceeds to block 810 with generating, based on at least the first V2X message, a BEV representation of the scene comprising the second apparatus during a second time period.

In some aspects, the second apparatus is outside of a sensor range of a sensor associated with the first apparatus during the second time period.

In some aspects, method 800 further includes detecting, based on the BEV representation, at least the second apparatus during the second time period.

In some aspects, method 800 further includes processing the first V2X message to generate a second V2X message, the second V2X message comprising information about the second apparatus in the scene during the second time period.

In some aspects, method 800 further includes extracting a plurality of V2X features from the second V2X message, wherein generating the BEV representation comprises generating the BEV representation of the scene based on, at least, projecting the plurality of V2X features from a V2X space to a BEV space.

In some aspects, generating the BEV representation of the scene based on, at least, projecting the plurality of V2X features from the V2X space to the BEV space, comprises: processing, by a first neural network, the plurality of V2X features and output a BEV query value; generating an initial 2D grid based on the plurality of V2X features; masking the initial 2D grid based on the BEV query value to generate an output 2D grid; and processing, by a second neural network, the output 2D grid to generate the BEV representation.

In some aspects, the first neural network comprises a multilayer perceptron.

In some aspects, a center of the initial 2D grid is associated with a center of the first apparatus; and a size of the initial 2D grid is based on at least one of: a communication range of the first apparatus; one or more performance limitations of the second neural network; or a sensor range of at least one sensor associated with the first apparatus.

In some aspects, method 800 further includes obtaining sensor data from one or more sensors associated with the first apparatus, wherein block 810 includes processing, by the second neural network, the output 2D grid and the sensor data to generate the BEV representation.

In some aspects, at least one of the first V2X message or the second V2X message comprise: a BSM; or a CAM.

In some aspects, the information about the second apparatus in the scene during the first time period, included in the first V2X message, comprises first state data and at least one of: cryptographic data; or identification data.

In some aspects, processing the first V2X message to generate the second V2X message comprises removing at least one of the cryptographic data or the identification data from the first V2X message.

In some aspects, processing the first V2X message to generate the second V2X message, comprises: processing, by a neural network, the first state data associated with the second apparatus in the scene during the first time period to predict second state data associated with the second apparatus in the scene during the second time period; and generating a first intermediate V2X message comprising the second state data.

In some aspects, the neural network comprises a LSTM network.

In some aspects, the second state data comprises a position of the second apparatus in the scene during the second time period; and processing the first V2X message to generate the second V2X message, comprises: generating third state data based on the second state data and a position of the first apparatus in the scene during the second time period, the third state data comprising at least a relative position of the second apparatus in the scene with respect to the position of the first apparatus during the second time period; and generating a second intermediate V2X message comprising the third state data, wherein the second V2X message comprises the second intermediate V2X message.

In some aspects, method 800 further includes adding the second intermediate V2X message to a data frame comprising a plurality of intermediate V2X messages.

In some aspects, method 800 further includes replacing an intermediate V2X message associated with the second apparatus in the data frame with the second intermediate V2X message.

In some aspects, method 800 further includes removing one or more intermediate V2X messages of the plurality of intermediate V2X messages from the data frame based on at least one of: a threshold distance from the position of the first apparatus in a vertical direction.

In some aspects, method 800 further includes aing threshold distance from the position of the first apparatus in a horizontal direction.

In some aspects, method 800 further includes adding one or more dummy intermediate V2X messages to the data frame, wherein generating the BEV representation comprises generating the BEV representation based on the plurality of V2X messages and the one or more dummy intermediate V2X messages in the data frame, including the second V2X message.

In some aspects, extracting the plurality of V2X features comprises extracting, by a convolutional neural network or a transformer, the plurality of V2X features from the second V2X message.

In some aspects, the plurality of V2X features comprise at least one of: first data included in the second V2X message; or second data computed based on the first data included in the second V2X message.

In some aspect, method 800, or any aspect related to it, may be performed by an apparatus, such as apparatus 1000 of FIG. 10, which includes various components operable, configured, or adapted to perform the method 800. Apparatus 1000 is described below in further detail.

Note that FIG. 8 is just one example of a method, and other methods including fewer, additional, or alternative operations are possible consistent with this disclosure.

### Example Sensor and Computing System

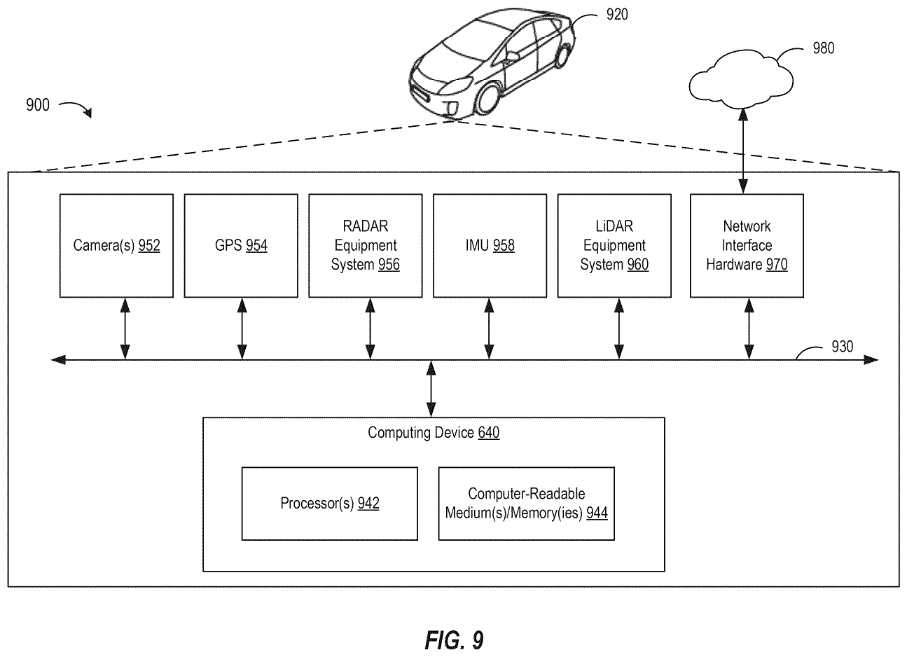

FIG. 9 depicts an example sensor and computing system 900 equipped, for example, in a vehicle 920 or other apparatus, such as a robot. The vehicle 920 depicted in FIG. 9 is depicted by way of an example schematic of a vehicle including sensor resources and a computing device. Not every vehicle may be required to be equipped with the same set of sensor resources, nor may every vehicle be required to be configured with the same set of systems for perceiving attributes of an environment. FIG. 9 only provides one example configuration of sensor resources and systems equipped within a vehicle 920. It is understood that aspects described herein are made with reference to implementation with, on, or in a vehicle 920. However, this is merely an example. The vehicle 920 may be any other apparatus.

In certain aspects, the computing system 900 of vehicle 920 may be configured to perform the method 600 described with respect to FIG. 6, or any aspect related to it, including any operations described in relation to FIG. 6; the method 700 described with respect to FIG. 7, or any aspect related to it, including any operations described in relation to FIG. 7; and the method 800 described with respect to FIG. 8, or any aspect related to it, including any operations described in relation to FIGS. 2-3.

In particular, FIG. 9 provides an example schematic of the vehicle 920 including a variety of sensor resources, which may be utilized, by the vehicle 920 to perceive and collect sensor data about the environment. For example, the vehicle 920 may include a computing device 940 comprising one or more processors 942 and one or more non-transitory computer readable medium(s)/memory(ies) 944, one or more cameras 952, a global positioning system (GPS) 954, a RADAR equipment system 956, IMU 958, a LiDAR equipment system 960, and network interface hardware 970.

In certain aspects, the vehicle 920 may not include all of the components depicted in FIG. 9. In certain aspects, the vehicle 920 may include one or more of the components, such as the one or more cameras 952, the GPS 954, the RADAR equipment system 956, the IMU 958, the LiDAR equipment system 960, a SONAR system, and/or the like. These and other components of the vehicle 920 may be communicatively connected to each other via a communication path 930.

The communication path 930 may be formed from any medium that is capable of transmitting a signal such as, for example, conductive wires, conductive traces, optical waveguides, or the like. The communication path 630 may also refer to the expanse in which electromagnetic radiation and their corresponding electromagnetic waves traverses. Moreover, the communication path 930 may be formed from a combination of mediums capable of transmitting signals. In one embodiment, the communication path 630 comprises a combination of conductive traces, conductive wires, connectors, and buses that cooperate to permit the transmission of electrical data signals to components such as processors, memories, sensors, input devices, output devices, and communication devices. Accordingly, the communication path 930 may comprise a bus. Additionally, it is noted that the term “signal” means a waveform (e.g., electrical, optical, magnetic, mechanical or electromagnetic), such as DC, AC, sinusoidal-wave, triangular-wave, square-wave, vibration, and the like, capable of traveling through a medium. As used herein, the term “communicatively coupled” means that coupled components are capable of exchanging signals with one another such as, for example, electrical signals via conductive medium, electromagnetic signals via air, optical signals via optical waveguides, and the like.

The computing device 940 may be any device or combination of components comprising one or more processors 942 and one or more non-transitory computer readable medium(s)/memory(ies) 944. The one or more processors 942 may be any device(s) capable of executing the processor-executable instructions stored in the one or more non-transitory computer readable medium(s)/memory(ies) 944. For example, each of the one or more processors 942 may be an electric controller, an integrated circuit, a microchip, a computer, or any other computing device. The one or more processors 942 are communicatively coupled to the other components of the vehicle 920 by the communication path 930. Accordingly, the communication path 930 may communicatively couple any number of processors 942 with one another, and allow the components coupled to the communication path 930 to operate in a distributed computing environment. Specifically, each of the components may operate as a node that may send and/or receive data.

The one or more non-transitory computer readable medium(s)/memory(ies) 944 may comprise RAM, ROM, flash memories, hard drives, or any non-transitory memory device capable of storing processor-executable instructions such that the processor-executable instructions can be accessed and executed by the one or more processors 942. The machine-readable instruction set may comprise logic or algorithm(s) written in any programming language of any generation (e.g., 1GL, 2GL, 3GL, 4GL, or 5GL, where GL stands for “generation language”) such as, for example, machine language that may be directly executed by the one or more processors 942, or assembly language, object-oriented programming (OOP), scripting languages, microcode, etc., that may be compiled or assembled into processor-executable instructions and stored in the one or more memories 944. Alternatively, the processor-executable instructions may be written in a hardware description language (HDL), such as logic implemented via either a FPGA configuration or an ASIC, or their equivalents. Accordingly, the functionality described herein may be implemented in any conventional computer programming language, as pre-programmed hardware elements, or as a combination of hardware and software components.

The vehicle 620 may further include one or more cameras 952. The one or more cameras 952 may be any device having an array of sensing devices (e.g., a charge-coupled device (CCD) array or active pixel sensors) capable of detecting radiation in an ultraviolet wavelength band, a visible light wavelength band, or an infrared wavelength band. The one or more cameras 952 may have any resolution. The one or more cameras 952 may be an omni-direction camera and/or a panoramic camera. In certain aspects, one or more optical components, such as a mirror, fish-eye lens, and/or any other type of lens may be optically coupled to the one or more cameras 952. The image data collected by the one or more cameras 952 may be stored in the one or more non-transitory computer readable medium(s)/memory(ies) 944.

GPS 654, may be coupled to the communication path 930 and communicatively coupled to the computing device 940 of the vehicle 920. The GPS 954 is capable of generating location information indicative of a location of the vehicle 920 by receiving one or more GPS signals from one or more GPS satellites. The GPS signal communicated to the computing device 640 via the communication path 930 may include location information including a message, a latitude and longitude data set, a street address, a name of a known location based on a location database, and/or the like. Additionally, the GPS 954 may be interchangeable with any other system capable of generating an output indicative of a location. For example, a local positioning system that provides a location based on cellular signals and broadcast towers or a wireless signal detection device capable of triangulating a location by way of wireless signals received from one or more wireless signal antennas. The sensor data collected by the GPS 954 may be stored in the one or more non-transitory computer readable medium(s)/memory(ies) 644.

RADAR equipment system 956 measures the distance to objects over wide distances. It is also possible to measure the relative speed of the detected object. The RADAR equipment system 656 may be a continuous wave (CW), frequency-modulated continuous wave (FMCW), 3D-radio detection and ranging equipment (3D FMCW multiple-input and multiple-output (MIMO)), or 4D-radio detection and ranging equipment (4D FMCW MIMO). The sensor data collected by the RADAR equipment system 956 may be stored in the one or more non-transitory computer readable medium(s)/memory(ies) 944.

IMU 958 is an electronic device that measures and reports vehicle 620's specific force, angular rate, and/or the orientation of the vehicle 920, using a combination of accelerometers, gyroscopes, and/or magnetometers. The sensor data collected by the IMU 958 may be stored in one or more non-transitory computer readable medium(s)/memory(ies) 944.

LiDAR equipment system 960 is communicatively coupled to the communication path 930 and the computing device 940. LiDAR equipment system 660 may be a system and method of using pulsed laser light to measure distances from the LiDAR equipment system 960 to objects that reflect the pulsed laser light. A LiDAR equipment system 960 may be made as solid-state devices with few or no moving parts, including those configured as optical phased array devices where its prism-like operation permits a wide field-of-view without the weight and size complexities associated with a traditional rotating LiDAR equipment system 960. LiDAR equipment system 960 may be particularly suited to measuring time-of-flight, which in turn may be correlated to distance measurements with object(s) that are within a field-of-view of the LiDAR equipment system 960. By calculating the difference in return time of the various wavelengths of the pulsed laser light emitted by the LiDAR equipment system 960, a digital 3D representation of an object and/or or environment may be generated. The pulsed laser light emitted by the LiDAR equipment system 960 may include emissions operated in and/or near the infrared range of the electromagnetic spectrum, for example, having emitted radiation of about 905 nanometers. Vehicle 920 may use LiDAR equipment system 960 to provide detailed 3D spatial information for the identification of object(s) near the vehicle 920, as well as the use of such information in the service of systems for vehicular mapping, navigation and autonomous operations. In certain aspects, period cloud data collected by the LiDAR equipment system 960 may be stored in the one or more non-transitory computer readable medium(s)/memory(ies) 944.

In certain aspects, vehicle 920 may be equipped with a vehicle-to-vehicle (V2V) communication system, which may rely on network interface hardware 970. The network interface hardware 970 may be coupled to the communication path 930 and communicatively coupled to the computing device 940. The network interface hardware 970 may be any device capable of transmitting and/or receiving data with a network 980 and/or directly with another vehicle equipped with a V2V/V2X communication system. Accordingly, network interface hardware 970 can include a communication transceiver for sending and/or receiving any wired and/or wireless communication. For example, the network interface hardware 970 may include an antenna, a modem, a local area network (LAN) port, a Wi-Fi card, a worldwide interoperability for microwave access (WiMax) card, mobile communications hardware, near-field communication (NFC) hardware, satellite communication hardware, and/or any wired or wireless hardware for communicating with other networks and/or devices. In certain aspects, network interface hardware 970 includes hardware configured to operate in accordance with the Bluetooth wireless communication protocol. In certain aspects, network interface hardware 970 may include a Bluetooth send/receive module for sending and/or receiving Bluetooth communications to/from network 980 and/or another vehicle or device.

### Example Apparatus for Object Detection

FIG. 10 depicts aspects of an example apparatus 1000. In certain aspects, apparatus 1000 is a computing device, such as computing device 940 depicted and described with respect to FIG. 9 (e.g., which may or may not be implemented by a vehicle 920).

The apparatus 1000 includes a processing system 1005, which may be coupled to a transceiver 1075 (e.g., a transmitter and/or a receiver). The transceiver 1075 is configured to transmit and receive signals for the apparatus 1000 via an antenna 1080, such as the various signals as described herein. The processing system 1005 may be configured to perform processing functions for the apparatus 1000, including processing signals received and/or to be transmitted by the apparatus 1000.

The processing system 1005 includes one or more processors 1004. Generally, processor(s) 1004 may be configured to execute computer-executable instructions (e.g., software code) to perform various functions, as described herein. The one or more processors 1004 are coupled to a computer-readable medium/memory 1041 via a bus 1070. In certain aspects, the computer-readable medium/memory 1041 is configured to store instructions (e.g., computer-executable code) that when executed by the one or more processors 1004, enable and cause the one or more processors 1004 to perform the method 600 described with respect to FIG. 6, or any aspect related to it, including any operations described in relation to FIG. 6; the method 700 described with respect to FIG. 7, or any aspect related to it, including any operations described in relation to FIG. 7; and the method 800 described with respect to FIG. 8, or any aspect related to it, including any operations described in relation to FIGS. 2 and 3. Note that reference to a processor performing a function of the apparatus 1000 may include one or more processors performing that function of the apparatus 1000, such as in a distributed fashion.

In the depicted example, computer-readable medium/memory 1041 stores code (e.g., executable instructions), including code for extracting 1032, code for generating 1034, code for detecting 1036, code for masking 1038, code for obtaining 1040, code for processing 1042, code for removing 1044, code for adding 1046, code for replacing 1048, code for sending 1050, code for projecting 152. Processing of the code 1032-1054 may enable and cause the apparatus 1000 to perform the method 600 described with respect to FIG. 6, or any aspect related to it; the method 700 described with respect to FIG. 7, or any aspect related to it; and the method 800 described with respect to FIG. 8, or any aspect related to it.

The one or more processors 1004 include circuitry configured to implement (e.g., execute) the code stored in the computer-readable medium/memory 1041, including circuitry for extracting 1006, circuitry for generating 1008, circuitry for detecting 1010, circuitry for masking 1012, circuitry for obtaining 1014, circuitry for processing 1016, circuitry for removing 1018, circuitry for adding 1020, circuitry for replacing 1022, circuitry for sending 1024, and circuitry for projecting 1026. Processing with circuitry 1006-1028 may enable and cause the apparatus 1000 to perform the method 600 described with respect to FIG. 6, or any aspect related to it; the method 700 described with respect to FIG. 7, or any aspect related to it; and the method 800 described with respect to FIG. 8, or any aspect related to it.

More generally, means for communicating, transmitting, sending or outputting for transmission may include the transceiver 1058 and/or antenna 1060 of the apparatus 1000 in FIG. 10, and/or one or more processors 1004 of the apparatus 1000 in FIG. 10. Means for communicating, receiving or obtaining may include the transceiver 1058 and/or antenna 1060 of the apparatus 1000 in FIG. 10, and/or one or more processors 1004 of the apparatus 1000 in FIG. 10.

Apparatus 1000 may be implemented in various ways. For example, apparatus 1000 may be implemented within on-site, remote, or cloud-based processing equipment.

Apparatus 1000 is just one example, and other configurations are possible. For example, in alternative aspects, aspects described with respect to apparatus 1000 may be omitted, added, or substituted for alternative aspects.

### Example Clauses

Implementation examples are described in the following numbered clauses:

Clause 1: A method for object detection by an apparatus comprising: extracting a plurality of V2X features from a first plurality of V2X messages, wherein the first plurality of V2X messages comprise information about one or more first objects in a scene during a first time period; generating a BEV representation of the scene based on, at least, projecting the plurality of V2X features from a V2X space to a BEV space; and detecting, based on the BEV representation, at least a first object among the one or more first objects in the scene.

Clause 2: The method of Clause 1, wherein generating the BEV representation of the scene based on, at least, projecting the plurality of V2X features from the V2X space to the BEV space, comprises: processing, by a first neural network, the plurality of V2X features and output a BEV query value; generating an initial 2D grid based on the plurality of V2X features; masking the initial 2D grid based on the BEV query value to generate an output 2D grid; and processing, by a second neural network, the output 2D grid to generate the BEV representation.

Clause 3: The method of Clause 2, wherein the first neural network comprises a multilayer perceptron.

Clause 4: The method of Clause 2, wherein: a center of the initial 2D grid is associated with a center of the apparatus; and a size of the initial 2D grid is based on at least one of: a communication range of the apparatus; one or more performance limitations of the second neural network; or a sensor range of at least one sensor associated with the apparatus.

Clause 5: The method of Clause 2, further comprising: obtaining sensor data from one or more sensors associated with the apparatus, wherein generating the BEV representation comprises processing, by the second neural network, the output 2D grid and the sensor data to generate the BEV representation.

Clause 6: The method of any one of Clauses 1-5, further comprising: processing a second plurality of V2X messages to generate the first plurality of V2X messages, wherein the second plurality of V2X messages comprise information about the one or more first objects in the scene during a second time period.

Clause 7: The method of Clause 6, wherein the second plurality of V2X messages comprise at least one of: a BSM; or a CAM.

Clause 8: The method of Clause 6, wherein: the second plurality of V2X messages comprise a first V2X message comprising information about the first object in the scene during the second time period; and the information about the first object comprises first state data and at least one of: cryptographic data; or identification data.

Clause 9: The method of Clause 8, wherein: the information about the first object comprises at least one of the cryptographic data or the identification data; and processing the second plurality of V2X messages to generate the first plurality of V2X messages comprises removing at least one of the cryptographic data or the identification data from the first V2X message.

Clause 10: The method of Clause 8, wherein processing the second plurality of V2X messages to generate the first plurality of V2X messages, comprises: processing, by a neural network, the first state data associated with the first object in the scene during the second time period to predict second state data associated with the first object in the scene during the first time period; and generating a first intermediate V2X message comprising the second state data.

Clause 11: The method of Clause 10, wherein the neural network comprises a LSTM network.

Clause 12: The method of Clause 10, wherein: the second state data comprises a position of the first object in the scene during the first time period; and processing the second plurality of V2X messages to generate the first plurality of V2X messages, comprises: generating third state data based on the second state data and a position of the apparatus in the scene during the first time period, the third state data comprising at least a relative position of the first object in the scene with respect to the position of the apparatus during the first time period; and generating a second intermediate V2X message comprising the third state data.

Clause 13: The method of Clause 12, wherein processing the second plurality of V2X messages to generate the first plurality of V2X messages, comprises: adding the second intermediate V2X message to a data frame comprising a plurality of intermediate V2X messages; or replacing an intermediate V2X message associated with the first object in the data frame with the second intermediate V2X message.

Clause 14: The method of Clause 13, wherein processing the second plurality of V2X messages to generate the first plurality of V2X messages, comprises removing one or more intermediate V2X messages of the plurality of intermediate V2X messages from the data frame based on at least one of: a threshold distance from the position of the apparatus in a vertical direction; or a threshold distance from the position of the apparatus in a horizontal direction.

Clause 15: The method of Clause 14, wherein processing the second plurality of V2X messages to generate the first plurality of V2X messages, comprises: adding one or more dummy intermediate V2X messages to the data frame, wherein the plurality of V2X messages and the one or more dummy intermediate V2X messages in the data frame comprise the first plurality of V2X messages.

Clause 16: The method of any one of Clauses 1-15, wherein extracting the plurality of V2X features comprises extracting, by a convolutional neural network or a transformer, the plurality of V2X features from the first plurality of V2X messages.

Clause 17: The method of any one of Clauses 1-16, wherein the plurality of V2X features comprise at least one of: first data included in the first plurality of V2X messages; or second data computed based on the first data included in the first plurality of V2X messages.

Clause 18: The method of any one of Clauses 1-17, wherein the first plurality of V2X messages comprise at least one of: a BSM; or a CAM.

Clause 19: A method for object detection by an apparatus comprising: sending an indication of a capability of the apparatus to generate, from at least V2X messages, a BEV representation of a scene; and obtaining, based on the indication of the capability, one or more first V2X messages from one or more other apparatuses.

Clause 20: The method of Clause 19, wherein: the one or more first V2X messages comprise information about one or more first objects in the scene during a first time period; and the method further comprises: processing the one or more first V2X messages to generate one or more second V2X messages, the one or more second V2X messages comprising information about the one or more first objects in the scene during a second time period; extracting a plurality of V2X features from the one or more second V2X messages; generating the BEV representation of the scene based on, at least, projecting the plurality of V2X features from a V2X space to a BEV space; and detecting, based on the BEV representation, at least a first object among the one or more first objects in the scene.

Clause 21: The method of Clause 20, wherein generating the BEV representation of the scene based on, at least, projecting the plurality of V2X features from the V2X space to the BEV space, comprises: processing, by a first neural network, the plurality of V2X features and output a BEV query value; generating an initial 2D grid based on the plurality of V2X features; masking the initial 2D grid based on the BEV query value to generate an output 2D grid; and processing, by a second neural network, the output 2D grid to generate the BEV representation.

Clause 22: The method of Clause 21, wherein the first neural network comprises a multilayer perceptron.

Clause 23: The method of Clause 21, wherein: a center of the initial 2D grid is associated with a center of the apparatus; and a size of the initial 2D grid is based on at least one of: a communication range of the apparatus; one or more performance limitations of the second neural network; or a sensor range of at least one sensor associated with the apparatus.

Clause 24: The method of Clause 21, further comprising obtaining sensor data from one or more sensors associated with the apparatus, wherein generating the BEV representation comprises processing, by the second neural network, the output 2D grid and the sensor data to generate the BEV representation.

Clause 25: The method of Clause 20, wherein at least one of the one or more first V2X messages or the one or more second V2X messages comprise at least one of: a BSM; or a CAM.

Clause 26: The method of Clause 20, wherein: the one or more first V2X messages comprise a first V2X message comprising information about the first object in the scene during the first time period; and the information about the first object comprises first state data and at least one of: cryptographic data; or identification data.

Clause 27: The method of Clause 26, wherein processing the one or more first V2X messages to generate the one or more second V2X messages comprises removing at least one of the cryptographic data or the identification data from the first V2X message.

Clause 28: The method of Clause 26, wherein processing the one or more first V2X messages to generate the one or more second V2X messages, comprises: processing, by a neural network, the first state data associated with the first object in the scene during the first time period to predict second state data associated with the first object in the scene during the second time period; and generating a first intermediate V2X message comprising the second state data.

Clause 29: The method of Clause 28, wherein the neural network comprises a LSTM network.

Clause 30: The method of Clause 28, wherein: the second state data comprises a position of the first object in the scene during the second time period; and processing the one or more first V2X messages to generate the one or more second V2X messages, comprises: generating third state data based on the second state data and a position of the apparatus in the scene during the second time period, the third state data comprising at least a relative position of the first object in the scene with respect to the position of the apparatus during the second time period; and generating a second intermediate V2X message comprising the third state data.

Clause 31: The method of Clause 30, wherein: the one or more second V2X messages comprise a plurality of second V2X messages; and processing the one or more first V2X messages to generate the plurality of second V2X messages, comprises: adding the second intermediate V2X message to a data frame comprising a plurality of intermediate V2X messages; or replacing an intermediate V2X message associated with the first object in the data frame with the second intermediate V2X message.

Clause 32: The method of Clause 31, wherein processing the one or more first V2X messages to generate the plurality of second V2X messages comprises removing one or more intermediate V2X messages of the plurality of intermediate V2X messages from the data frame based on at least one of: a threshold distance from the position of the apparatus in a vertical direction; or a threshold distance from the position of the apparatus in a horizontal direction.

Clause 33: The method of Clause 32, wherein processing the one or more first V2X messages to generate the plurality of second V2X messages, comprises: adding one or more dummy intermediate V2X messages to the data frame, wherein the plurality of V2X messages and the one or more dummy intermediate V2X messages in the data frame comprise the plurality of second V2X messages.

Clause 34: The method of Clause 20, wherein extracting the plurality of V2X features comprises extracting, by a convolutional neural network or a transformer, the plurality of V2X features from the one or more second V2X messages.

Clause 35: The method of Clause 20, wherein the plurality of V2X features comprise at least one of: first data included in the one or more second V2X messages; or second data computed based on the first data included in the one or more V2X messages.

Clause 36: A method for object detection by an apparatus comprising: obtaining, from a second apparatus, a first V2X message comprising information about the second apparatus in a scene during a first time period; and generating, based on at least the first V2X message, a BEV representation of the scene comprising the second apparatus during a second time period.

Clause 37: The method of Clause 36, wherein the second apparatus is outside of a sensor range of a sensor associated with the first apparatus during the second time period.

Clause 38: The method of Clause 37, further comprising detecting, based on the BEV representation, at least the second apparatus during the second time period.

Clause 39: The method of any one of Clauses 36-38, further comprising: processing the first V2X message to generate a second V2X message, the second V2X message comprising information about the second apparatus in the scene during the second time period; and extracting a plurality of V2X features from the second V2X message, wherein generating the BEV representation comprises generating the BEV representation of the scene based on, at least, projecting the plurality of V2X features from a V2X space to a BEV space.

Clause 40: The method of Clause 39, wherein generating the BEV representation of the scene based on, at least, projecting the plurality of V2X features from the V2X space to the BEV space, comprises: processing, by a first neural network, the plurality of V2X features and output a BEV query value; generating an initial 2D grid based on the plurality of V2X features; masking the initial 2D grid based on the BEV query value to generate an output 2D grid; and processing, by a second neural network, the output 2D grid to generate the BEV representation.

Clause 41: The method of Clause 40, wherein the first neural network comprises a multilayer perceptron.

Clause 42: The method of Clause 40, wherein: a center of the initial 2D grid is associated with a center of the first apparatus; and a size of the initial 2D grid is based on at least one of: a communication range of the first apparatus; one or more performance limitations of the second neural network; or a sensor range of at least one sensor associated with the first apparatus.

Clause 43: The method of Clause 40, further comprising obtaining sensor data from one or more sensors associated with the first apparatus, wherein generating the BEV representation comprises processing, by the second neural network, the output 2D grid and the sensor data to generate the BEV representation.

Clause 44: The method of Clause 39, wherein at least one of the first V2X message or the second V2X message comprise: a BSM; or a CAM.

Clause 45: The method of Clause 39, wherein the information about the second apparatus in the scene during the first time period, included in the first V2X message, comprises first state data and at least one of: cryptographic data; or identification data.

Clause 46: The method of Clause 45, wherein processing the first V2X message to generate the second V2X message comprises removing at least one of the cryptographic data or the identification data from the first V2X message.

Clause 47: The method of Clause 45, wherein processing the first V2X message to generate the second V2X message, comprises: processing, by a neural network, the first state data associated with the second apparatus in the scene during the first time period to predict second state data associated with the second apparatus in the scene during the second time period; and generating a first intermediate V2X message comprising the second state data.

Clause 48: The method of Clause 47, wherein the neural network comprises a LSTM network.

Clause 49: The method of Clause 47, wherein: the second state data comprises a position of the second apparatus in the scene during the second time period; and processing the first V2X message to generate the second V2X message, comprises: generating third state data based on the second state data and a position of the first apparatus in the scene during the second time period, the third state data comprising at least a relative position of the second apparatus in the scene with respect to the position of the first apparatus during the second time period; and generating a second intermediate V2X message comprising the third state data, wherein the second V2X message comprises the second intermediate V2X message.

Clause 50: The method of Clause 49, further comprising: adding the second intermediate V2X message to a data frame comprising a plurality of intermediate V2X messages; and replacing an intermediate V2X message associated with the second apparatus in the data frame with the second intermediate V2X message.

Clause 51: The method of Clause 50, further comprising: removing one or more intermediate V2X messages of the plurality of intermediate V2X messages from the data frame based on at least one of: a threshold distance from the position of the first apparatus in a vertical direction; and aing threshold distance from the position of the first apparatus in a horizontal direction.

Clause 52: The method of Clause 51, further comprising adding one or more dummy intermediate V2X messages to the data frame, wherein generating the BEV representation comprises generating the BEV representation based on the plurality of V2X messages and the one or more dummy intermediate V2X messages in the data frame, including the second V2X message.

Clause 53: The method of Clause 39, wherein extracting the plurality of V2X features comprises extracting, by a convolutional neural network or a transformer, the plurality of V2X features from the second V2X message.

Clause 54: The method of Clause 39, wherein the plurality of V2X features comprise at least one of: first data included in the second V2X message; or second data computed based on the first data included in the second V2X message.

Clause 55: One or more apparatuses, comprising: one or more memories comprising executable instructions; and one or more processors configured to execute the executable instructions and cause the one or more apparatuses to perform a method in accordance with any one of Clauses 1-54.

Clause 56: One or more apparatuses configured for object detection, comprising: one or more memories; and one or more processors, coupled to the one or more memories, configured to cause the one or more apparatuses to perform a method in accordance with any one of Clauses 1-54.

Clause 57: One or more apparatuses configured for object detection, comprising: one or more memories; and one or more processors, coupled to the one or more memories, configured to perform a method in accordance with any one of Clauses 1-54.

Clause 58: One or more apparatuses, comprising means for performing a method in accordance with any one of Clauses 1-54.

Clause 59: One or more non-transitory computer-readable media comprising executable instructions that, when executed by one or more processors of one or more apparatuses, cause the one or more apparatuses to perform a method in accordance with any one of Clauses 1-54.

Clause 60: One or more computer program products embodied on one or more computer-readable storage media comprising code for performing a method in accordance with any one of Clauses 1-54.

Clause 61: One or more apparatuses configured for object detection, comprising: a processing system that includes one or more processors and one or more memories coupled with the one or more processors, the processing system configured to cause the one or more apparatuses to perform a method in accordance with any one of Clauses 1-54.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “a controller,” “a memory,” “a transceiver,” “an antenna,” “the processor,” “the controller,” “the memory,” “the transceiver,” “the antenna,” etc.), unless otherwise specifically stated, should be understood to refer to one or more elements (e.g., “one or more processors,” “one or more controllers,” “one or more memories,” “one more transceivers,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus configured for object detection, comprising a processing system that includes one or more processors and one or more memories coupled with the one or more processors, the processing system configured to cause the apparatus to:
send an indication of a capability of the apparatus to generate, from at least vehicle-to-everything (V2X) messages, a bird's eye view (BEV) representation of a scene; and
based on the indication of the capability, obtain one or more first V2X messages from one or more other apparatuses.

2. The apparatus of claim 1, wherein:
the one or more first V2X messages comprise information about one or more first objects in the scene during a first time period; and
the processing system is configured to cause the apparatus to:
process the one or more first V2X messages to generate one or more second V2X messages, the one or more second V2X messages comprising information about the one or more first objects in the scene during a second time period;
extract a plurality of V2X features from the one or more second V2X messages;
generate the BEV representation of the scene based on, at least, projecting the plurality of V2X features from a V2X space to a BEV space; and
detect, based on the BEV representation, at least a first object among the one or more first objects in the scene.

3. The apparatus of claim 2, wherein to cause the apparatus to generate the BEV representation of the scene based on, at least, projecting the plurality of V2X features from the V2X space to the BEV space, the processing system is configured to cause the apparatus to:
process, by a first neural network, the plurality of V2X features and output a BEV query value;
generate an initial two-dimensional (2D) grid based on the plurality of V2X features;
mask the initial 2D grid based on the BEV query value to generate an output 2D grid; and
process, by a second neural network, the output 2D grid to generate the BEV representation.

4. The apparatus of claim 3, wherein:
a center of the initial 2D grid is associated with a center of the apparatus; and
a size of the initial 2D grid is based on at least one of:
a communication range of the apparatus;
one or more performance limitations of the second neural network; or
a sensor range of at least one sensor associated with the apparatus.

5. The apparatus of claim 3, wherein:
the processing system is configured to cause the apparatus to obtain sensor data from one or more sensors associated with the apparatus; and
to cause the apparatus to generate the BEV representation, the processing system is configured to cause the apparatus to process, by the second neural network, the output 2D grid and the sensor data to generate the BEV representation.

6. The apparatus of claim 2, wherein at least one of the one or more first V2X messages or the one or more second V2X messages comprise at least one of:
a basic safety message (BSM); or
a cooperative awareness message (CAM).

7. The apparatus of claim 2, wherein:
the one or more first V2X messages comprise a first V2X message comprising information about the first object in the scene during the first time period; and
the information about the first object comprises first state data and at least one of:
cryptographic data; or
identification data.

8. The apparatus of claim 7, wherein to cause the apparatus to process the one or more first V2X messages to generate the one or more second V2X messages, the processing system is configured to cause the apparatus to:
remove at least one of the cryptographic data or the identification data from the first V2X message.

9. The apparatus of claim 7, wherein to cause the apparatus to process the one or more first V2X messages to generate the one or more second V2X messages, the processing system is configured to cause the apparatus to:
process, by a neural network, the first state data associated with the first object in the scene during the first time period to predict second state data associated with the first object in the scene during the second time period; and
generate a first intermediate V2X message comprising the second state data.

10. The apparatus of claim 9, wherein:
the second state data comprises a position of the first object in the scene during the second time period; and
to cause the apparatus to process the one or more first V2X messages to generate the one or more second V2X messages, the processing system is configured to cause the apparatus to:
generate third state data based on the second state data and a position of the apparatus in the scene during the second time period, the third state data comprising at least a relative position of the first object in the scene with respect to the position of the apparatus during the second time period; and
generate a second intermediate V2X message comprising the third state data.

11. The apparatus of claim 10, wherein:
the one or more second V2X messages comprise a plurality of second V2X messages; and
to cause the apparatus to process the one or more first V2X messages to generate the plurality of second V2X messages, the processing system is configured to cause the apparatus to:
add the second intermediate V2X message to a data frame comprising a plurality of intermediate V2X messages; or
replace an intermediate V2X message associated with the first object in the data frame with the second intermediate V2X message.

12. The apparatus of claim 11, wherein to cause the apparatus to process the one or more first V2X messages to generate the plurality of second V2X messages, the processing system is configured to cause the apparatus to remove one or more intermediate V2X messages of the plurality of intermediate V2X messages from the data frame based on at least one of:
a threshold distance from the position of the apparatus in a vertical direction; or
a threshold distance from the position of the apparatus in a horizontal direction.

13. The apparatus of claim 12, wherein to cause the apparatus to process the one or more first V2X messages to generate the plurality of second V2X messages, the processing system is configured to cause the apparatus to:
add one or more dummy intermediate V2X messages to the data frame,
wherein the plurality of V2X messages and the one or more dummy intermediate V2X messages in the data frame comprise the plurality of second V2X messages.

14. The apparatus of claim 2, wherein the plurality of V2X features comprise at least one of:
first data included in the one or more second V2X messages; or
second data computed based on the first data included in the one or more V2X messages.

15. A method of object detection by an apparatus, comprising:
sending an indication of a capability of the apparatus to generate, from at least vehicle-to-everything (V2X) messages, a bird's eye view (BEV) representation of a scene; and
based on the indication of the capability, obtaining one or more first V2X messages from one or more other apparatuses.

16. The method of claim 15, wherein:
the one or more first V2X messages comprise information about one or more first objects in the scene during a first time period; and
the method further comprises:
processing the one or more first V2X messages to generate one or more second V2X messages, the one or more second V2X messages comprising information about the one or more first objects in the scene during a second time period;
extracting a plurality of V2X features from the one or more second V2X messages;
generating the BEV representation of the scene based on, at least, projecting the plurality of V2X features from a V2X space to a BEV space; and
detecting, based on the BEV representation, at least a first object among the one or more first objects in the scene.

17. The method of claim 16, wherein generating the BEV representation of the scene based on, at least, projecting the plurality of V2X features from the V2X space to the BEV space comprises:
processing, by a first neural network, the plurality of V2X features and output a BEV query value;
generating an initial two-dimensional (2D) grid based on the plurality of V2X features;
masking the initial 2D grid based on the BEV query value to generate an output 2D grid; and
processing, by a second neural network, the output 2D grid to generate the BEV representation.

18. The method of claim 17, wherein:
a center of the initial 2D grid is associated with a center of the apparatus; and
a size of the initial 2D grid is based on at least one of:
a communication range of the apparatus;
one or more performance limitations of the second neural network; or
a sensor range of at least one sensor associated with the apparatus.

19. The method of claim 17, further comprising:
obtaining sensor data from one or more sensors associated with the apparatus,
wherein generating the BEV representation comprises processing, by the second neural network, the output 2D grid and the sensor data to generate the BEV representation.

20. One or more non-transitory computer-readable media comprising executable instructions that, when executed by one or more processors of an apparatus, cause the apparatus to perform operations comprising:
sending an indication of a capability of the apparatus to generate, from at least vehicle-to-everything (V2X) messages, a bird's eye view (BEV) representation of a scene; and
based on the indication of the capability, obtaining one or more first V2X messages from one or more other apparatuses.
